(19) United States
(12) Patent Application Publication
(10) Pub. No.: US 2026/0173117 A1
(43) Pub. Date: Jun. 18, 2026

(54) MANAGING BROADCAST, MULTICAST AND UNICAST DATA COMMUNICATIONS

(71) Applicant: GOOGLE LLC, Mountain View, CA (US)

(72) Inventor: Chih-Hsiang Wu, Taoyuan City (TW)

(21) Appl. No.: 18/702,578

(22) PCT Filed: Oct. 19, 2022
(86) PCT No.: PCT/US2022/047082

§ 371 Date: Apr. 18, 2024

Related U.S. Application Data
(60) Provisional application No. 63/270,536, filed on Oct. 21, 2021.
(60) Provisional application No. 63/350,357, filed on Jun. 8, 2022.

(51) Int. Cl. H04W 72/30; H04L 1/00; H04L 69/322

(52) U.S. Cl. CPC H04W 72/30; H04L 1/0061; H04L 69/322

(57) ABSTRACT

A base station can implement a method for transmitting multicast and/or broadcast services (MBS) to a user equipment (UE). The method may include receiving (1202) unicast data for the UE; receiving (1204) MBS data for the UE; and transmitting (1208), to the UE, the MBS data and the unicast data in different respective PDUs without multiplexing the MBS data and the unicast data.

### FIELD OF THE DISCLOSURE

This disclosure relates to wireless communications and, more particularly, to enabling unicast, multicast and/or broadcast data communications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul, in what is referred to as dual connectivity (DC) operation. These network nodes may all be nodes using the same radio access technology (RAT) or may include nodes using different RATs. Example DC configurations include NR-only dual connectivity (NR-DC) and EUTRA and NR dual connectivity (EN-DC). When a UE operates in DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier in 5G NR, 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface, while in PTM communications a RAN node transmits a single copy of each MBS data packet to multiple UEs over the radio interface. In some scenarios, however, it is unclear how a base station should transmit an MBS data packet via broadcast, multicast, and/or unicast.

### SUMMARY

A base station and/or a UE can use the techniques of this disclosure for managing transmission/reception of MBS data.

In some implementations, a base station receives both MBS data and unicast data for transmission to a UE. The base station can determine whether to include the MBS data and the unicast data in the same packet (e.g., in the same protocol data unit (PDU)) or in different packets depending on whether the MBS data is to be transmitted to the UE via unicast or multicast. If the MBS data is to be transmitted to the UE via unicast, then the base station can include the MBS data and the unicast data in a single packet, and unicast this packet to the UE. If the MBS data is to be transmitted to the UE via multicast, then the base station can include the MBS data and the unicast in two different packets, and multicast and unicast the two packets to the UE, respectively.

Further, a base station can use the techniques of this disclosure to configure a logical channel identifier for a radio bearer. In particular, the base station can configure the logical channel identifier (e.g., set a value for the logical channel identifier, and/or select a type of logical channel identifier) based on whether the radio bearer is a multicast radio bearer (MRB) or unicast radio bearer (e.g., a data radio bearer (DRB) or signaling radio bearer (SRB)). Correspondingly, a UE can determine how to process a PDU depending on whether the PDU is received via multicast or unicast (e.g., depending on a logical channel identifier received with the PDU).

One example embodiment of these techniques is a method in a base station for transmitting multicast and/or broadcast services (MBS) to a user equipment (UE). The method can be executed by processing hardware and includes receiving unicast data for the UE; receiving MBS data for the UE; determining whether the MBS data is to be transmitted to the UE via multicast or unicast; in a first instance, in response to determining that the MBS data is to be transmitted to the UE via multicast, transmitting, to the UE, the MBS data and the unicast data in different respective PDUs; and, in a second instance, in response to determining that the MBS is to be transmitted to the UE via unicast, transmitting, to the UE, the MBS data and the unicast data in a single PDU.

Another example embodiment of these techniques is a method in a base station for configuring radio bearers for transmissions to a UE. The method can be executed by processing hardware and includes: selecting a logical channel identifier for a radio bearer based on whether the radio bearer is a unicast radio bearer or a multicast radio bearer; and transmitting the logical channel identifier to the UE.

Yet another example embodiment of these techniques is a base station including processing hardware and configured to implement one of the methods above.

A further example embodiment of these techniques is a method in a UE for processing transmissions received from a base station. The method can be executed by processing hardware and includes receiving data from the base station; determining whether the UE received the data via multicast or unicast; and, based on the determining, selecting a radio link control (RLC) configuration and/or a packet data convergence protocol (PDCP) configuration, with which to process the data.

Another example embodiment of these techniques is a UE including processing hardware and configured to implement the method above.

### BRIEF DESCRIPTION OF THE DRAWINGS

FIG. 1A is a block diagram of an example system in which the techniques of this disclosure for managing resources for multicast and/or broadcast services (MBS) can be implemented;

FIG. 1B is a block diagram of an example base station in which a central unit (CU) and a distributed unit (DU) can operate in the system of FIG. 1A;

FIG. 2 is a block diagram of an example protocol stack according to which the UE of FIG. 1A can communicate with base stations of FIG. 1A;

FIG. 3 is a block diagram illustrating example tunnel architectures for MBS sessions and PDU sessions;

FIG. 4 is a block diagram illustrating example MRBs and DRBs which a distributed base station can configure for communicating multicast, broadcast, and/or unicast traffic with UEs;

FIGS. 5A-5C are messaging diagrams of example scenarios in which a CN and a distributed base station configure resources for transmitting MBS data of an MBS session to multiple UEs;

FIG. 6A is a flow diagram of an example method for transmitting a protocol data unit (PDU) including both unicast data and multicast data to a UE, which can be implemented by a RAN node of FIG. 1A or 1B;

FIG. 6B is a flow diagram of an example method for transmitting separate PDUs including unicast data and multicast data, respectively, to a UE, which can be implemented by a RAN node of FIG. 1A or 1B;

FIG. 7A is a flow diagram of an example method for scheduling a multicast data transmission and a unicast data transmission using a group radio network temporary identifier (G-RNTI) and a cell RNTI (C-RNTI), respectively, which can be implemented by a RAN node of FIG. 1A or 1B;

FIG. 7B is a flow diagram of an example method for scheduling a PDU transmission, the PDU including unicast data and multicast data, using a C-RNTI, which can be implemented by a RAN node of FIG. 1A or 1B;

FIG. 8 is a flow diagram of an example method for determining how to configure an MBS data transmission depending on whether the MBS data is to be transmitted via multicast or unicast, which can be implemented by a RAN node of FIG. 1A or 1B;

FIG. 9A is a flow diagram of an example method for determining how to process a PDU based on whether the PDU is received via multicast or unicast, which can be implemented by a UE of FIG. 1A;

FIG. 9B is a flow diagram of an example method for determining how to process a PDU based on whether the PDU is received via multicast, broadcast, or unicast, which can be implemented by a UE of FIG. 1A;

FIGS. 9C-9D are flow diagrams an example method for determining how to process a PDU based on a logical channel identifier received with the PDU, which can be implemented by a UE of FIG. 1A;

FIG. 10A is a flow diagram of an example method for determining how to set a value of a logical channel identifier for a radio bearer based on whether the radio bearer is a multicast radio bearer (MRB) or a unicast radio bearer, which can be implemented by a RAN node of FIG. 1A or 1B;

FIG. 10B is a flow diagram of an example method for determining how to set a value of a logical channel identifier for a radio bearer based on whether the radio bearer is a multicast radio bearer (MRB, a data radio bearer (DRB), or a signaling radio bearer (SRB), which can be implemented by a RAN node of FIG. 1A or 1B;

FIG. 11A is a flow diagram of an example method for determining how to configure a logical channel identifier for a radio bearer based on whether the radio bearer is a multicast radio bearer (MRB) or a unicast radio bearer, which can be implemented by a RAN node of FIG. 1A or 1B;

FIG. 11B is a flow diagram of an example method for determining how to configure a logical channel identifier for a radio bearer based on whether the radio bearer is a multicast radio bearer (MRB, a data radio bearer (DRB), or a signaling radio bearer (SRB), which can be implemented by a RAN node of FIG. 1A or 1B;

FIG. 12 is a flow diagram of an example method for transmitting MBS to a UE, which can be implemented by a base station of FIG. 1A;

FIG. 13 is a flow diagram of an example method for configuring radio bearers for transmissions to a UE, which can be implemented by a base station of FIG. 1A; and

FIG. 14 is a flow diagram of an example method for processing transmissions received from a base station, which can be implemented by a UE of FIG. 1A.

### DETAILED DESCRIPTION OF THE DRAWINGS

Generally speaking, a RAN and/or a CN implement the techniques of this disclosure to manage transmission of multicast and/or broadcast services (MBS). A CN can request that a base station configure a common downlink (DL) tunnel via which the CN can transmit MBS data for an MBS session to the base station, for multiple UEs. In response to the request, the base station transmits a configuration of the common DL tunnel to the CN.

The configuration can include transport-layer information such as an Internet Protocol (IP) address and a tunnel identifier (e.g., a Tunnel Endpoint Identifier (TEID)).

The base station can also configure one or more logical channels toward the UEs, and/or one or more MBS radio bearers (MRBs) associated with the MBS session, where there may be a one-to-one mapping between each logical channel and each MRB. After receiving MBS data for the MBS session via the common DL tunnel, the base station can transmit the MBS data via the one or more logical channels to one or more UEs that have joined the MBS session. In some implementations, the base station transmits MBS data to multiple UEs via a single logical channel. Further, if there are multiple quality-of-service (QoS) flows for the MBS session, a single logical channel may be associated with the multiple QoS flows, or there may be a one-to-one mapping between each QoS flow and each logical channel.

The CN can cause the base station to configure the common DL tunnel before or after a UE joins the MBS session. If additional UEs join the MBS session after the tunnel is configured, the CN can utilize the same common DL tunnel to transmit MBS data, for the multiple UEs, to the base station.

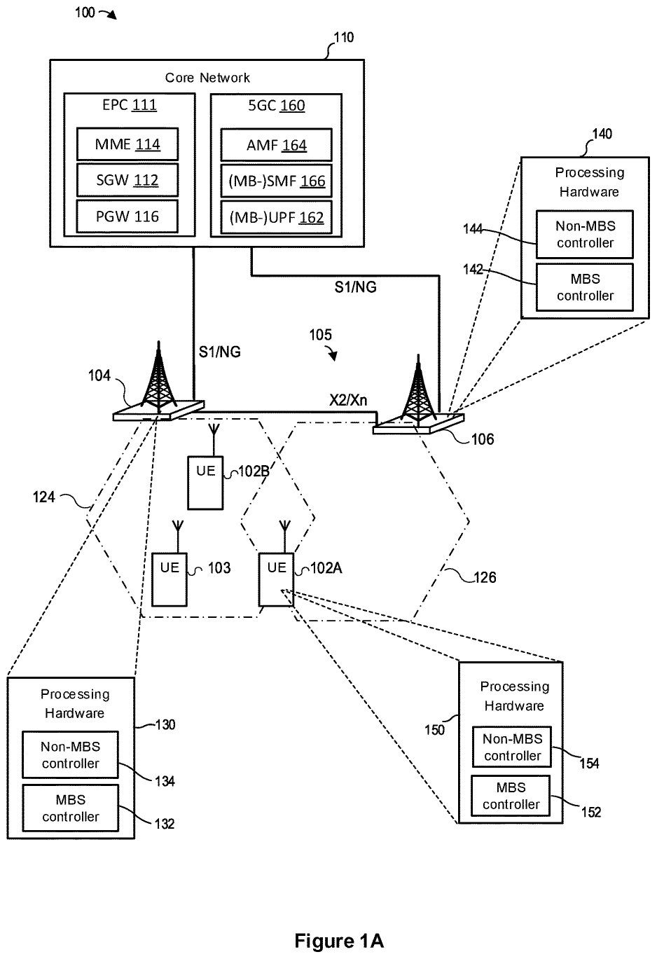

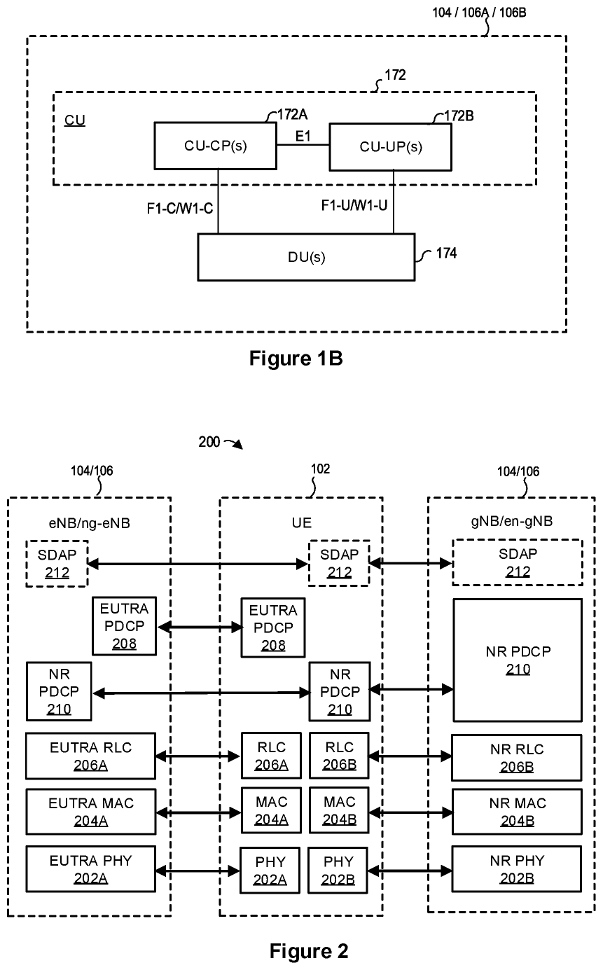

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, 103A, 103B, as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A.

The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows the various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UE 102B may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6 G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the El interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

The description above can apply to the UEs 102B, 103A and 103B.

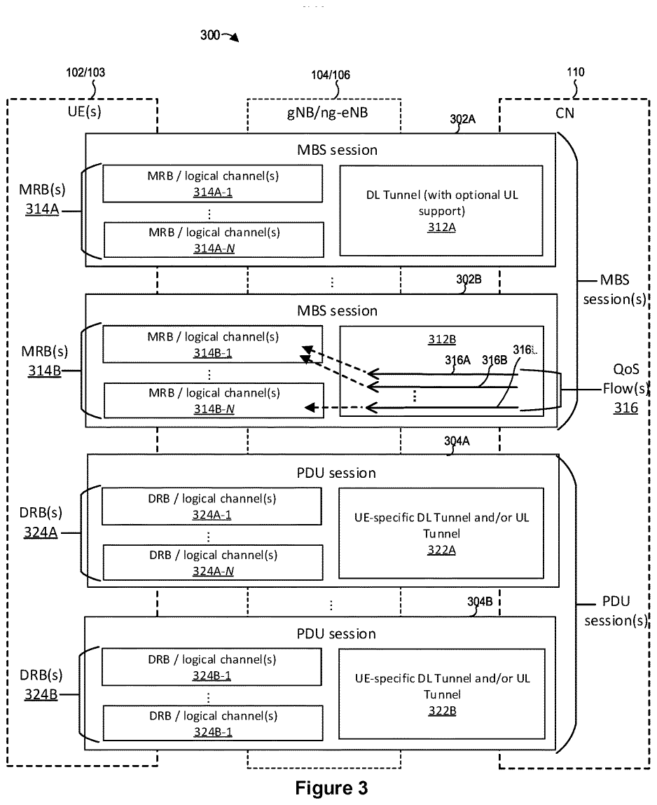

FIG. 2 illustrates, in a simplified manner, an example protocol stack 200 according to which a UE (e.g., UE 102A, 102B, 103A or 103B) can communicate with an eNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE, in some implementations, supports both the EUTRA and the NR stack as shown in FIG. 2, to support handover between EUTRA and NR base stations and/or to support DC over EUTRA and NR interfaces. Further, as illustrated in FIG. 2, the UE can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE operates in EN-DC with the base station 104 operating as an MeNB and the base station 106 operating as an SgNB, the wireless communication system 100 can provide the UE with an MN-terminated bearer that uses EUTRA PDCP sublayer 208, or an MN-terminated bearer that uses NR PDCP sublayer 210. The wireless communication system 100 in various scenarios can also provide the UE with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts MBS data packets via one or more MBS radio bearers (MRB(s)), and in turn the UE receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE uses PHY sublayer 202, MAC sublayer 204, and RLC sublayer 206 to receive the MBS data packets. In such implementations, the base station and the UE might or might not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE uses PHY sublayer 202, MAC sublayer 204, RLC sublayer 206 and PDCP sublayer 208 to receive the MBS data packets. In such implementations, the base station and the UE might or might not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE uses the PHY sublayer 202, MAC sublayer 204, RLC sublayer 206, PDCP sublayer 208, and SDAP sublayer 212 to receive the MBS data packets.

In some implementations, the base station 104 and/or 106 may include a DU (e.g., DU 174) and a CU (e.g., the CU 172). In such implementations, the radio protocol stack 200 may be functionally split. The CU at any of the base stations 104 or 106 can hold all the control and upper layer functionalities (e.g., RRC layer, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to the RRC layer, and NR PDCP 210 provides DRBs to SDAP 212 and SRBs to the RRC layer.

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and an GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QoS) flows, for each of the tunnels 312A, 312B, etc. For example, the MBS traffic on the tunnel 312B can include a set of flows 316 including QoS flows 316A, 316B, . . . 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific DL tunnel 322A corresponding to one or more DRBs 324A, such as a DRB 324A-1, 324A-2, . . . 324-N. Each of the DRBs 324A can correspond to a respective logical channel, such as a Dedicated Traffic Channel (DTCH).

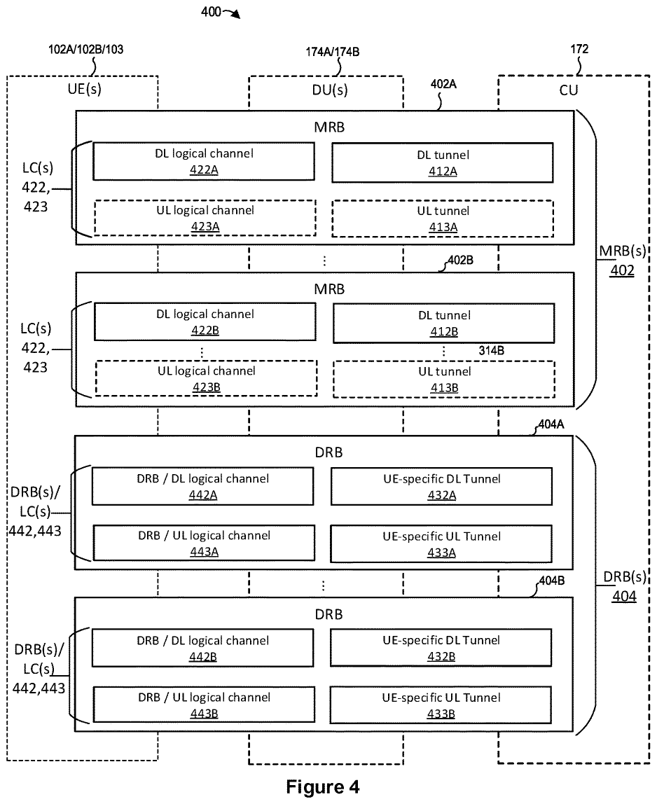

Now referring to FIG. 4, when the base station 104/106 is implemented in a distributed manner, the CU 172 and the DU 174A/174B can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU 174A/174B, and a DL logical channel 422A corresponding to the DL tunnel 412A. In particular, the DU 174A/174B can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs.

Optionally, the MRB 402A also includes a UL tunnel 413A connecting the CU 172 and the DU 174A/174B, and a UL logical channel 423A corresponding to the UL tunnel 413A. The UL logical channel 423A can be a PUCCH, for example. The DU 174A/174B can map uplink traffic received via the UL logical channel 423A to the UL tunnel 413A.

The tunnels 412A and 413A can operate at the transport layer or sublayer of the F1-U interface. As a more specific example, the CU 172 and the DU 174A/174B can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU 174A/174B can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU 174A/174B, and a DL logical channel 442A corresponding to the DL tunnel 432A In particular, the DU 174A/174B can map downlink traffic received via the DL tunnel 432A to the DL logical channel 442A, which can be a DTCH, for example. The DRB 404A further includes a UE-specific UL tunnel 433A connecting the CU 172 and the DU 174A/174B, and a UL logical channel 443A corresponding to the UL tunnel 433A. The UL logical channel 443A can be a PUSCH, for example. The DU 174A/174B can map uplink traffic received via the UL logical channel 443A to the UL tunnel 433A.

Similarly, A DRB 404B can include a UE-specific DL tunnel 432B corresponding to a DL logical channel 442B, and a UE-specific UL tunnel 433B corresponding to a UL logical channel 443B.

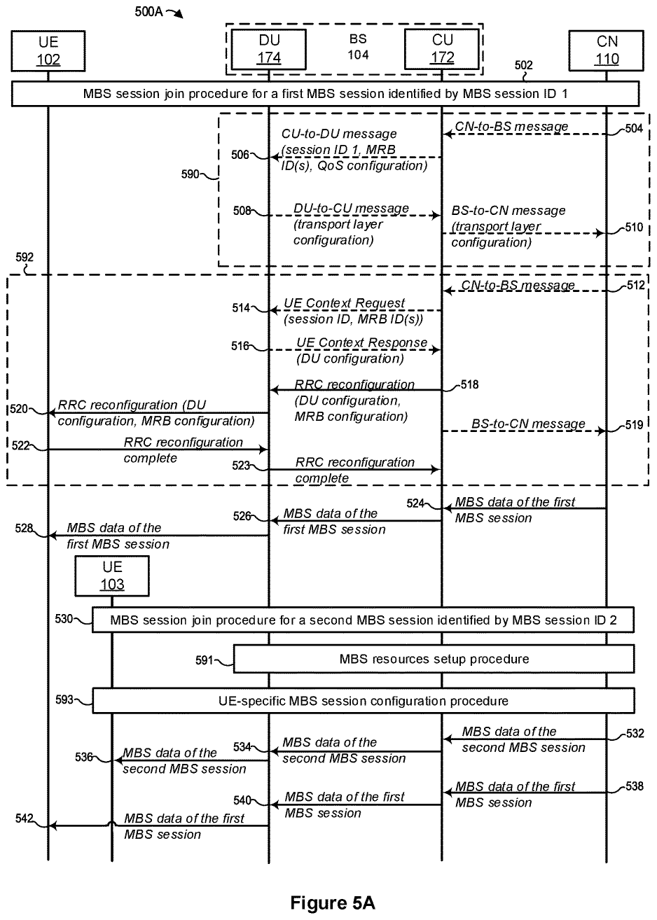

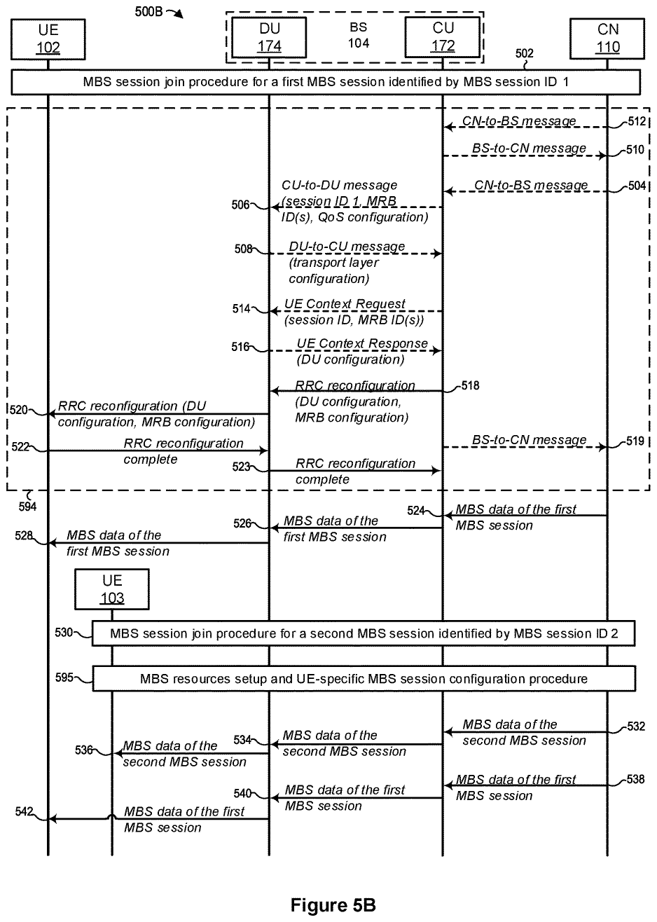

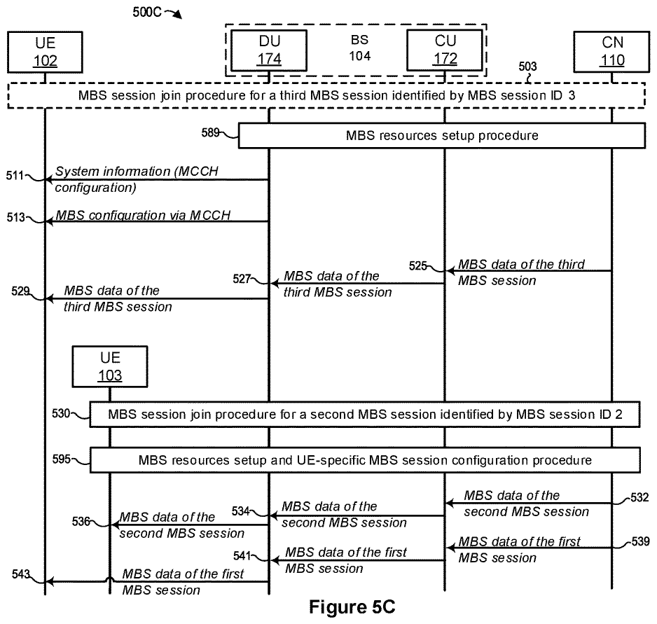

Next, FIG. 5A illustrates an example scenario 500A in which the base station 104, including a CU 172 and a DU 174, configures resources for transmitting MBS data of an MBS session.

The UE 102 (i.e., (each of) the UEs 102A and/or 102B) initially performs 502 a (first) MBS session join procedure with the CN 110 via the base station 104 to join a certain MBS session (i.e., a first MBS session). Because the base station 104 configures a common DL tunnel for MBS traffic rather than a UE-specific tunnel, as discussed below, the procedures 502 and 590 can occur in either order. In other words, the base station 104 can configure a common DL tunnel before even a single UE joins the MBS session.

To perform the MBS session join procedure, the UE 102 in some implementations sends an MBS session join request message to the CN 110 via the base station 104. In response, the CN 110 can send an MBS session join response message to the UE 102 via the base station 104 to grant the UE 102 access to the first MBS session. In some implementations, the UE 102 can include a first MBS session ID (e.g., MBS session ID 1) of the first MBS session in the MBS session join request message. The CN 110 in some cases includes the first MBS session ID in the MBS session join response message. In some implementations, the UE 102 can send an MBS session join complete message to the CN 110 via the base station 104 in response to the MBS session join response message.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management messages (5GSM). In the case of the 5GSM messages, the UE 102 can transmit to the CN 110 via the base station 104 a (first) UL container message including the MBS session join request message, the CN 110 can transmit to the UE 102 via the base station 104 a DL container message including the MBS session join response message, and the UE 102 can transmit to the CN 110 via the base station 104 a (second) UL container message including the MBS session join complete message. These container messages can be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the MBS session join request message, the MBS session join response message, and/or the MBS session join complete message can represent the container messages.

In some implementations, the UE 102 can perform a PDU session establishment procedure with the CN 110 via the base station 104 to establish a PDU session in order to perform the (first) MBS session join procedure. During the PDU session establishment procedure, the UE 102 can communicate a PDU session ID of the PDU session with the CN 110 via the base station 104.

Before, during, or after the (first) MBS session join procedure (event 502), the CN 110 can send 504 a (first) CN-to-BS message including the first MBS session ID (e.g., MBS session ID 1) and/or the PDU session ID to the CU 172 to request the CU 172 to configure resources for the first MBS session. In response to receiving 504 the first CN-to-BS message, the CU 172 can send 506 a CU-to-DU message to the DU 174 to request a set-up for an MBS context and/or a common DL tunnel for the first MBS session. In response to receiving 506 the first CU-to-DU message, the DU 174 can send 508, to the CU 172, a DU-to-CU message including a first DU DL transport layer configuration to configure a common CU-to-DU DL tunnel for the first MBS session. In some implementations, the CU-to-DU message is a generic F1AP message or a dedicated F1AP message defined specifically to convey this type of a request (e.g., MBS Context Setup Request message). In some implementations, the DU-to-CU message of event 508 is a generic F1AP message or a dedicated F1AP message defined specifically for this purpose (e.g., MBS Context Setup Response message). The CN 110 can additionally include quality of service (QoS) configuration(s) for the first MBS session. In such cases, the CU 172 can include the QoS configuration(s) in the CU-to-DU message (event 506). In some implementations, the CU-to-DU message and DU-to-CU message can be non-UE-specific messages.

The CU 172 sends 510 a first BS-to-CN message (e.g., MBS Session Resource Setup Response message) in response to the message of event 504. The CU 172 can include the first MBS session ID and/or the PDU session ID in the first BS-to-CN message. The first BS-to-CN message can include a DL transport layer configuration to configure a common DL tunnel for the CN 110 to send MBS data to the CU 172. The DL transport layer configuration includes a transport layer information, such as a transport layer address (e.g., an IP address) and/or a TEID, to identify the common DL tunnel. In some implementations, the CN-to-BS message of event 504 is a generic NGAP message or a dedicated NGAP message defined specifically for requesting resources for an MBS session (e.g., MBS Session Resource Setup Request message). In some implementations, the BS-to-CN message of event 510 is a generic NGAP message or a dedicated NGAP message defined specifically to convey resources for an MBS session (e.g., MBS Session Resource Setup Response message). In such cases, the CN-to-BS message of event 504 and the BS-to-CN message of event 510 can be non-UE-specific messages.

In some implementations, the QoS configuration(s) include QoS parameters for the MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5QI), a priority level, packet delay budget, packet error rate, averaging window, and/or a maximum data burst volume. The CN 110 can specify different values of the QoS parameters for the QoS flows.

The events 504, 506, 508, and 510 are collectively referred to in FIG. 5A as an MBS resource setup procedure 590.

In some implementations, the CN 110 can indicate, in the first CN-to-BS message, a list of UEs joining the first MBS session. In other implementations, the CN 110 can send 512 to the CU 172 a second CN-to-BS message indicating a list of UEs joining the first MBS session. The CN 110 can include the first MBS session ID and/or the PDU session ID in the second CN-to-BS message. The CU 172 can send 519 a second BS-to-CN message to the CN 110 in response to the second CN-to-BS message 512. In such cases, the second CN-to-BS message can be a non-UE-specific message, i.e., a message not specific for the UE 102A or the UE 102B. The CU 172 can include the first MBS session ID and/or the PDU session ID in the second BS-to-CN message. For example, the list of UEs includes the UE 102A and/or UE 102B. To indicate a list of UEs, the CN 110 can include a list of (CN UE interface ID, RAN UE interface ID) pairs, each identifying a particular UE of the UEs. The CN 110 assigns the CN UE interface ID, and the CU 172 assigns the RAN UE interface ID. Before the CN 110 sends the list of (CN UE interface ID, RAN UE interface ID) pairs, the CU 172 sends a BS-to-CN message (e.g., a NGAP message, an INITIAL UE MESSAGE or PATH SWITCH REQUEST message) including the RAN UE interface ID to the CN 110 for each of the UEs, and the CN 110 sends a CN-to-BS message (e.g., a NGAP message, an INITIAL CONTEXT SETUP REQUEST message or PATH SWITCH REQUEST ACKNOWLEDGE message) including the CN UE interface ID to the CU 172 for each of the UEs. In one example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be a “AMF UE NGAP ID” and the “RAN UE interface ID” can be a “RAN UE NGAP ID”. In other implementations, the CN 110 can include a list of UE IDs each identifying a particular UE of the UEs. In some implementations, the CN 110 can assign the UE IDs and send each of the UE IDs to a particular UE of the UEs in a NAS procedure (e.g., a registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs). Before the CN 110 sends the list of UE IDs, the CU 172 can receive the UE ID from the UE 102 or the CN 110 for each of the UEs. For example, the CU 172 can receive an RRC message (e.g., an RRCSetupComplete message) including the UE ID from the UE 102 during an RRC connection establishment procedure. In another example, the CU 172 can receive a CN-to-BS message (e.g., a NGAP message, an INITIAL CONTEXT SETUP REQUEST message or UE INFORMATION TRANSFER message) including the UE ID from the CN 110.

In other implementations, the CN 110 can send 512 to the CU 172 a second CN-to-BS message indicating (only) the UE 102 (i.e., either the UE 102A or the UE 102B) joins the first MBS session. The second CN-to-BS message can be a UE-associated message for the UE 102. That is, the second CN-to-BS message is specific for the UE 102. In response to receiving the second CN-to-BS message, the CU 172 can send 514 to the DU 174 a UE Context Request message for the UE 102. In some implementations, the CU 172 can include, in the UE Context Request message, the first MBS session ID and/or MRB ID(s) of MRB(s) associated to the first MBS session (ID). In response to the UE Context Request message, the DU 174 sends 516 to the CU 172 a UE Context Response message including configuration parameters for the UE 102A to receive MBS data of the first MBS session. In some implementations, the CU 172 can include the QoS configuration(s) in the UE Context Request message. In such cases, the CU 172 might or might not include the QoS configuration(s) in the CU-to-DU message. (Some of) the configuration parameters may be associated to the MRB(s)/MRB ID(s). In some implementations, the DU 174 generates a DU configuration to include the configuration parameters and includes the DU configuration in the UE Context Response message. In some implementations, the DU configuration can be a CellGroupConfig IE. In other implementations, the DU configuration can be an MBS specific IE. In some implementations, the configuration parameters configure one or more logical channels (LCs). For example, the configuration parameters include one or more logical channel IDs (LCIDs) to configure the one or more logical channel. Each of the LCIDs identifies a particular logical channel of the one or more logical channels.

In some implementations, the second CN-to-BS message and the second BS-to-CN message can be a PDU Session Resource Modify Request message and a PDU Session Resource Modify Response message, respectively.

In some implementations, the CN 110 includes the QoS configuration(s) in the second CN-to-BS message. In such cases, the CN 110 may include the QoS configuration(s) in the first CN-to-BS message, or omit the QoS configuration(s). In some implementations, the DU 174 generates the configuration parameters for the UE 102 to receive MBS data of the first MBS session in response receiving the CU-to-DU message or the UE Context Request message. In some implementations, the CU 172 includes the QoS configuration(s) in the UE Context Request message and/or the CU-to-DU message. The DU 174 can determine the content of the configuration parameters in accordance with the QoS configuration(s). When the CU 172 includes the QoS configuration(s) neither in the CU-to-DU message nor the UE Context Request message, the DU 174 can determine values of the configuration parameters in accordance with a predetermined QoS configuration.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

After receiving 516 the UE Context Response message, the CU 172 generates an RRC reconfiguration message including the configuration parameters and one or more MRB configurations and transmits 518 the RRC reconfiguration message to the DU 174. In turn, the DU 174 transmits 520 the RRC reconfiguration message to the UE 102. In response, the UE 102 then transmits 522 an RRC reconfiguration complete message to the DU 174, which in turn transmits 523 the RRC reconfiguration complete message to the CU 172.

In some implementations, the CU 172 generates a PDCP PDU including the RRC reconfiguration message and sends 518 a CU-to-DU message including the PDCP PDU to the DU 174, and the DU 174 retrieves the PDCP PDU from the CU-to-DU message and transmits 520 the PDCP PDU to the UE 102 via the RLC layer 206B, MAC layer 204B and PHY layer 202B. The UE 102 receives 520 the PDCP PDU from the DU 174 via the PHY layer 202B, MAC layer 204B and RLC layer 206B. In some implementations, the UE 102 generates a PDCP PDU including the RRC reconfiguration complete message and transmits 522 the PDCP PDU to the DU 174 via the RLC layer 206B, MAC layer 204B and PHY layer 202B. The DU 174 receives 522 the PDCP PDU from the UE 102 via the PHY layer 202B, MAC layer 204B and RLC layer 206B and sends 523 a DU-to-CU including the PDCP PDU to the CU 172. The CU 172 retrieves the PDCP PDU from the DU-to-CU message and retrieves the RRC reconfiguration complete message from the PDCP PDU.

Before or after receiving 516 the UE Context Response message, the CU 172 can send 519 a second BS-to-CN message to the CN 110 in response to the second CN-to-BS message 512. In some implementations, the CU 172 sends 519 the second BS-to-CN message to the CN 110 before receiving 523 the RRC reconfiguration complete message. In other implementations, the CN 110 sends 519 the second BS-to-CN message to the CN 110 after receiving 523 the RRC reconfiguration complete message. The CU 172 can include the first CN UE interface ID and the first RAN UE interface ID in the second BS-to-CN message. Alternatively, the CU 172 can include the first UE ID in the second BS-to-CN message.

The events 512, 514, 516, 518, 519, 520, 522 and 523 are collectively referred to in FIG. 5A as a UE-specific MBS session resource configuration procedure 592. In some implementations, respective instances of the events 512, 514, 516, 518, 519, 520, 522, 523 occur for each of the UE 102A and the UE 102B. The configuration parameters for the UE 102A and the UE 102B to receive MBS data of the first MBS session can be the same. In some implementations, the MBS session join procedure of event 502 include the UE-specific MBS session resource setup procedure 592. In such cases, the CN 110 can include the MBS session join response message for the UE 102 in the second CN-to-BS message.

In some implementations, the CU 172 can include the CU DL transport layer configuration(s) in the second BS-to-CN message. In other words, the CU 172 can send the same CU DL transport layer configuration(s) in BS-to-CN messages in responses to CN-to-BS messages indicating UEs joining the same MBS session. Similarly, the DU 174 can include the first DU DL transport layer configuration(s) in the UE Context Response message. In other words, the DU 174 can send the same DU DL transport layer configuration(s) in DU-to-CU messages in responses to CU-to-DU messages indicating UEs joining the same MBS session. In such implementations, the CN 110 can blend the MBS resource setup procedure 590 and the second CN-to-BS and BS-to-CN messages into a single procedure.

In cases where the CU 172 performs the MBS resource setup procedure 590 (e.g., events 504, 510) with the CN 110 to establish the common CN-to-BS DL tunnel for the first MBS session, the CU 172 may refrain from including a DL transport layer configuration for the first MBS session in the second BS-to-CN message. In such cases, the CN 110 may refrain from including a UL transport layer configuration for the first MBS session in the second CN-to-BS message. In cases where the DU 174 performs the MBS resource setup procedure 590 (e.g., events 506, 508) with the CU 172 to establish the common CU-to-DU DL tunnel for the first MBS session, the DU 174 may refrain from including a DL transport layer configuration for the first MBS session in the UE Context Response message. In such cases, the CU 172 may refrain from including a UL transport layer configuration for the first MBS session in the UE Context Request message.

After receiving 510 the first BS-to-CN message or 519 the second BS-to-CN message, the CN 110 can send 524 MBS data (e.g., one or multiple MBS data packets) to the CU 172 via the common CN-to-BS DL tunnel (i.e., the first common CN-to-BS DL tunnel), which in turn sends the 526 the MBS data to the DU 174 via the common CU-to-DU DL tunnel (i.e., the first common CU-to-DU DL tunnel). The DU 174 transmits (e.g., multicast or unicast) 528 the MBS data via the one or more logical channels to the UE 102 (i.e., the UE 102A and the UE 102B). The UE 102 receives 528 the MBS data via the one or more logical channels. For example, the CU 172 receives 524 an MBS data packet, generates a PDCP PDU including the MBS data packet and transmits 526 the PDCP PDU to the DU 174. In turn, the DU 174 generates a MAC PDU including the logical channel ID and the PDCP PDU, and transmits 528 the MAC PDU to the UE 102 via multicast or unicast. The UE 102 receives 528 the MAC PDU via multicast or unicast, retrieves the PDCP PDU and the logical channel ID from the MAC PDU, identifies the PDCP PDU associated with the MRB and retrieves the MBS data packet from the PDCP PDU.

In some implementations, the one or more MRB configurations configuring one or more MRBs are associated with the first MBS session. In some implementations, the configuration parameters also include one or more RLC bearer configurations, each associated with a particular MRB. Each of the MRB configuration(s) can include an MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a multicast traffic channel (MTCH). In other implementations, the logical channel can be a dedicated traffic channel (DTCH). In some implementations, the configuration parameters may include logical channel configuration (e.g., LogicalChannelConfig IE) configuring configure the logical channel. In some implementations, the RLC bearer configuration may include the MRB ID.

In some implementations, the CU 172 can configure the MRB as a DL-only RB in the MRB configuration. For example, the CU 172 refrains from including UL configuration parameters in the PDCP configuration within the MRB configuration to configure the MRB as a DL only RB. The CU 172 only includes DL configuration parameters in the MRB configuration, e.g., as described above. In such cases, the CU 172 configures the UE 102 not to transmit UL PDCP data PDU via the MRB to the DU 174 and/or the CU 172 by excluding the UL configuration parameters for the MRB in the PDCP configuration in the MBR configuration. In another example, the DU 174 refrains from including UL configuration parameters in the RLC bearer configuration. In such cases, the DU 174 configures the UE 102 not to transmit control PDU(s) via the logical channel to the DU 174 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU 172. For example, the CU 172 may configure the UE to receive MBS data with a (de)compression protocol (e.g., robust header compression (ROHC) protocol), e.g., in the MRB configuration. In this case, when the CU 172 receives 524 an MBS data packet from the CN 110, the CU 172 compresses the MBS data packet with the compression protocol to obtain a compressed MBS data packet and transmits 526 a PDCP PDU including the compressed MBS data packet to the DU 174 via the common CU-to-DU DL tunnel. In turn, the DU 174 transmits (e.g., multicast or unicast) 528 the PDCP PDU to the UE 102 via the logical channel. When the UE 102 receives the PDCP PDU via the logical channel, the UE 102 retrieves the compressed MBS data packet from the PDCP PDU. The UE 102 decompresses the compressed MBS data packet with the (de)compression protocol to obtain the original MBS data packet. In such cases, the UE 102 may transmit a PDCP Control PDU including, a header compression protocol feedback (e.g., interspersed ROHC feedback) for operation of the header (de)compression protocol, via the logical channel to the DU 174. In turn, the DU 174 sends the PDCP Control PDU to the CU 172 via a UE-specific UL tunnel, i.e., the UL tunnel is specific for the UE 102 (e.g., the UE 102A). In some implementations, the CU 172 can include, in the UE Context Request message, a CU UL transport layer configuration configuring the UE-specific UL tunnel. The CU UL transport layer configuration includes a CU transport layer address (e.g., an Internet Protocol (IP) address) and a CU UL TEID to identify the UE-specific UL tunnel.

In some implementations, the MRB configuration can be an MRB-ToAddMod IE including an MRB ID (e.g., mrb-Identity or MRB-Identity). An MRB ID identifies a particular MRB of the MRB(s). The CU 172 sets the MRB IDs to different values. In cases where the CU 172 has configured DRB(s) to the UE 102 for unicast data communication, the CU 172 in some implementations can set the MRB ID(s) to values different from DRB ID(s) of the DRB(s). In such cases, the UE 102 and the CU 172 can distinguish whether an RB is an MRB or a DRB in accordance an RB ID of the RB. In other implementations, the CU 172 can set one or more of the MRB ID(s) to values which can be the same as one or more of the DRB ID(s). In such cases, the UE 102 and the CU 172 can distinguish whether an RB is an MRB or a DRB in accordance an RB ID of the RB and an RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine an RB is an DRB if the UE 102 receives a DRB-ToAddMod IE configuring the RB, and determine an RB is an MRB if the UE 102 receives an MRB-ToAddMod IE configuring the RB. Similarly, the CU 172 can determine an RB is an DRB if the CU 172 transmits a DRB-ToAddMod IE configuring the RB to the UE 102, and determine an RB is an MRB if the CU 172 transmits an MRB-ToAddMod IE configuring the RB to the UE 102.

In some implementations, the configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)). In some implementations, the configuration parameters might or might not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the CU 172 can include the MBS session join response message in the RRC reconfiguration message. The UE 102 can include the MBS session join complete message in the RRC reconfiguration complete message. Alternatively, the UE 102 can send a UL RRC message including the MBS session join complete message to the CU 172 via the DU 174. The UL RRC message can be a ULInformationTransfer message or any suitable RRC message that can include a UL NAS PDU. The CU 172 can include the MBS session join complete message in the second BS-to-CN message. Alternatively, the CU 172 can send to the CN 110 a BS-to-CN message (e.g., an UPLINK NAS TRANSPORT message) including the MBS session join complete message.

In other implementations, the CU 172 transmits a DL RRC message that MBS session join response message to the UE 102 via the DU 174. The DL RRC message can be a DLInformationTransfer message, another RRC reconfiguration message, or any suitable RRC message that can include a DL NAS PDU. The UE 102 can send a UL RRC message including the MBS session join complete message to the CU 172 via the DU 174. The UL RRC message can be a ULInformationTransfer message, another RRC reconfiguration complete message or any suitable RRC message that can include a UL NAS PDU.

With continued reference to FIG. 5A, the UE 103 (e.g., (each of) the UE 103A and/or the UE 103B) can perform 530 an MBS session join procedure to join a second MBS session identified by a second MBS session ID (e.g., MBS session ID 2), similar to the procedure 502 discussed above. The base station 104 can perform 591 an MBS session resources setup procedure with the CN 110 to configure a second common CN-to-BS DL tunnel and a second common CU-to-DU DL tunnel for the second MBS session, similar to the procedure 590. The base station 104 can perform 593 a UE-specific MBS session configuration procedure with the UE 103 and the CN 110 to transmit to the UE 103 configuration parameters and one or more MRB configurations for the second MBS session, similar to the procedure 590. Some or all of the configuration parameters and the MRB configuration(s) of the procedure 593 may be different from the configuration parameters and the MRB configuration(s) of the procedure 592. For example, the configuration parameters of the procedure 593 includes a second G-RNTI (value) different from the G-RNTI (value) within the configuration parameters of the procedure 592. In another example, the MRB configuration(s) of the procedure 593 includes MRB ID(s) different from the MRB ID(s) within the configuration parameters of the procedure 592.

After the UE 103 has joined 530 the second MBS session and obtained the necessary RRC configuration and the CN 110 performs 591 the procedure, the CN 110 can send 532 MBS data (e.g., one or multiple MBS data packets) to the CU 172 via the second common CN-to-BS DL tunnel, similar to event 524. In turn, the CU 172 sends the 534 the MBS data to the DU 174 via the second common CU-to-DU DL tunnel, similar to event 526. The DU 174 transmits (e.g., multicast or unicast) 536 the MBS data via the one or more logical channels to the UE 103 (i.e., the UE 103A and the UE 103B), similar to event 528. The UE 103 receives 536 the MBS data via the one or more logical channels, similar to event 528.

After the CU 172 performs the procedure 591 with the CN 110 and the DU 174, and the UE 103 has joined 530 the second MBS session and obtained the necessary RRC configuration, the CU 172 continues to receive 538 MBS data via the first common CN-to-BS DL tunnel and transmits 540 the MBS data to the DU 174 via the first common CU-to-DU DL tunnel. In some implementations, the DU 174 transmits 542 the MBS data to the UE 102A and UE 102B via multicast, similar to event 528. The UE 102A and UE 102B can receive 542 MBS data similar to event 528. Alternatively, the base station 104 can transmit the MBS data to the UE 102A and UE 102B separately via unicast, similar to event 528. In this case, the UE 102A and UE 102B can receive 542 MBS data separately via unicast, similar to event 528.

Referring next to FIG. 5B, a scenario 500B is depicted which is generally similar to the scenario 500A. Events in this scenario similar to those discussed above are labeled with the same reference numbers and the examples and implementations for FIG. 5A can apply to FIG. 5B. The differences between the scenarios of FIG. 5A and FIG. 5B are discussed below.

In some implementations, the CU 172 can perform an MBS session resource setup procedure (i.e., events 510 and 504) with the CN 110 in response to receiving 512 the second CN-to-BS message. In such implementations, the CU 172 transmits 510 the first BS-to-CN message to the CN 110 in response to receiving 512 the second CN-to-BS message. Then, the CN 110 transmits 504 the first CN-to-BS message to the CU 172 in response to receiving 510 the first BS-to-CN message. In such cases, the CN 110 might or might not include an MBS session ID (i.e., the first MBS session ID) in the first CN-to-BS message. The CN 110 can transmit 519 the BS-to-CN message in response to or after receiving 512 the second CN-to-BS message or 504 the first CN-to-BS message. After or in response to receiving 512 the second CN-to-BS message, transmitting 510 the second BS-to-CN message or receiving 504 the first CN-to-BS message, the CU 172 can transmit 506 the CU-to-DU message to the DU 174.

The events 512, 510, 504, 506, 508, 514, 516, 518, 519, 520, 522 and 523 are collectively referred to in FIG. 5B as an MBS resource setup and UE-specific MBS session configuration procedure 594. The base station 104 can perform 595 an MBS resource setup and UE-specific MBS session configuration procedure with the UE 103 and the CN 110 to transmit to the UE 103 configuration parameters and one or more MRB configurations for the second MBS session, similar to the procedure 594.

Referring next to FIG. 5C, a scenario 500C is depicted which is generally similar to the scenarios 500A and 500B. Events in this scenario similar to those discussed above are labeled with the same reference numbers and the examples and implementations for FIGS. 5A and 5B can apply to FIG. 5C. The differences among the scenarios of FIG. 5A, FIGS. 5B and 5C are discussed below.

In the scenario 500C, the base station 104 broadcasts a certain MBS session (i.e., a third MBS session identified by a third MBS session ID (e.g., MBS session ID 3). The base station 104 can also multicast the second MBS session as described for FIG. 5A. The UE 102 (i.e., (each of) the UEs 102A and/or 102B) initially can perform 503 a (third) MBS session join procedure with the CN 110 via the base station 104 to join the third MBS session, similar to event 502 of FIG. 5A. Alternatively, the UE 102 does not perform an MBS session join procedure to receive the third MBS session.

The CN 110 and base station 104 performs 589 an MBS resources setup procedure to establish a common CN-to-BS DL tunnel and a common CU-to-DU DL tunnel to transmit MBS data of the third MBS session, similar to event 590 of FIG. 5A. Before or after the MBS resources setup procedure 589, the DU 174 transmits (e.g., broadcast) 511 system information (e.g., one or more system information blocks (SIBs)) including MBS control channel (MCCH) configuration on one or more cells (e.g., cell 124 and/or other cell(s) operated by the DU 174). The DU 174 transmits (e.g., broadcast) 513 at least one MBS configuration via a MCCH configured by the MCCH configuration.

In some implementations, the MCCH configuration includes configuration parameters such as a window start slot, a window duration, a modification period, and/or a repetition period and offset. The window duration indicates a duration (i.e., MCCH transmission window in units of e.g., (consecutive) slots), starting from a slot indicated by the window start slot, during which transmissions of MCCH information (i.e., transmission(s) of the MBS configuration(s) via MCCH) may be scheduled. The modification period defines periodically appearing boundaries, i.e., radio frames for which SFN mod the modification period=0. Contents of different transmissions of MCCH information can only be different if there is at least one such boundary in-between them. The repetition period and offset parameter defines a length and an offset of the MCCH repetition period. Transmissions of MCCH information are scheduled in radio frames for which: SFN mod repetition period length offset of the repetition period.

In some implementations, the MBS configuration(s) includes MBS session information (i.e., information related one or more MBS sessions). The MBS session information includes a list of {MBS session ID, G-RNTI, MRB configuration, RLC bearer configuration and/or DRX information} tuple(s). The MBS session ID identifies an MBS session, the G-RNTI is used to schedule transmissions of MBS data of the MBS session, the MRB configuration configures one or more MRBs, and the DRX information configures DRX related parameters for transmission of MBS data of the MBS session. In the scenario 500C, the MBS session information includes the third MBS session ID, a G-RNTI used by the DU 174 to schedule transmissions of MBS data, an MRB configuration configuring one or more MRBs for the third MBS session, and/or DRX information configuring DRX related parameters for transmission of MBS data of the third MBS session.

In some implementations, the DU 174 can (start to) transmit 511 the system information in response to performing 589 the MBS resource setup procedure. In some implementations, the CU 172 generates the system information and transmit the system information to the DU 174. In other implementations, the DU 174 generates the system information.

In some implementations, the DU 174 can (start to) transmit 513 the MBS configuration(s) in response to performing 589 the MBS resource setup procedure. In some implementations, the CU 172 generates the MBS configuration and transmit the MBS configuration to the DU 174, e.g., as described below. In other implementations, the DU 174 generates the MBS configuration as described below.

In some implementations, the CU 172 can transmit to the DU 174 a CU-to-DU message including configuration parameters for the third MBS session, such as the third MBS session ID, QOS configuration(s), DRX cycle information, MRB ID(s) of the MRB(s), and/or PDCP configuration(s) of the MRB(s). In some implementations, the DU 174 can generate the MBS session information in accordance with the configuration parameters. In cases where the DU 174 does not receive a configuration parameter from the CU 172, the DU 174 can generate a configuration parameter of the MBS session information in accordance with a default parameter (i.e., preconfigured value(s)). For example, the DU 174 can generate the MRB configuration(s), which includes the PDCP configuration(s), the MRB ID(s) and/or the third MBS session ID. The DU 174 can generate the RLC bearer configuration(s) (e.g., including the MRB ID(s)) for the MRB(s), e.g., in accordance with the QoS configuration(s) and/or the MRB ID(s). The DU 174 can assign logical channel ID(s) for the MRB(s) and include the logical channel ID(s) in the MBS configuration or the RLC bearer configuration(s). In another example, the DU 174 can generate the DRX information configuring a DRX cycle in accordance with the DRX cycle information. In yet another example, the DU 174 can include the third MBS session ID in the MBS session information. In yet another example, the DU 174 can assign the G-RNTI and associate the G-RNTI with the third MBS session ID. In such cases, the DU 174 can generate the MBS session information and the MBS configuration (e.g., an MBS broadcast configuration message) including the MBS session information, and transmit 513 the MBS configuration via the MCCH on the one or more cells. In some implementations, the CU-to-DU message can be a CU-to-DU message of the MBS resource setup procedure 589, similar to event 506. In other implementations, the CU-to-DU message can be a (second) message other than the CU-to-DU message of the MBS resource setup procedure 589.

In other implementations, the DU 174 can transmit to the CU 172 a DU-to-CU message including the RLC bearer configuration(s), the DRX information and the G-RNTI. In such implementations, the CU 172 generates the MRB configuration(s), which includes the PDCP configuration(s), the MRB ID(s) and/or the third MBS session ID. In such cases, the CU 172 generates the MBS session information and the MBS configuration (e.g., an MBS broadcast configuration message) including the MBS session information, for (each of) the one or more cells. Then the CU 172 transmits a CU-to-DU message including the MBS configuration to the DU 174. After receiving the MBS configuration from the CU 172, the DU 174 transmits 513 the MRB configuration via the MCCH.

After the MBS resources setup procedure 589, the CN 110 sends 525 MBS data of the third MBS session to the CU 172 via the common CN-to-BS DL tunnel, similar to event 524. In turn, the CU 172 transmits 527 the MBS data to the DU 174 via the common CU-to-DU DL tunnel, similar to event 526. The DU 174 then transmits (i.e., broadcast) 529 the MBS data, similar to event 528. After receiving the MBS configuration, the UE 102 receives 529 the MBS data, similar to event 528.

After the UE 103 joins 530 the second MBS session, the CN 110 sends 539 MBS data of the third MBS session to the CU 172 via the common CN-to-BS DL tunnel, similar to event 538. In turn, the CU 172 transmits 541 the MBS data to the DU 174 via the common CU-to-DU DL tunnel, similar to event 540. The DU 174 then transmits (i.e., broadcast) 543 the MBS data, similar to event 542. After receiving the MBS configuration, the UE 102 receives 543 the MBS data, similar to event 542.

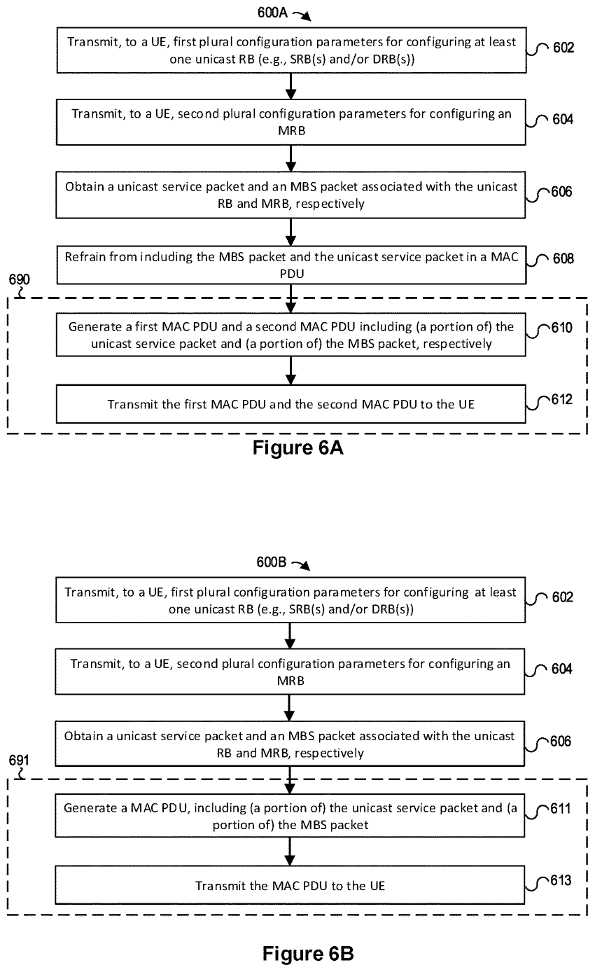

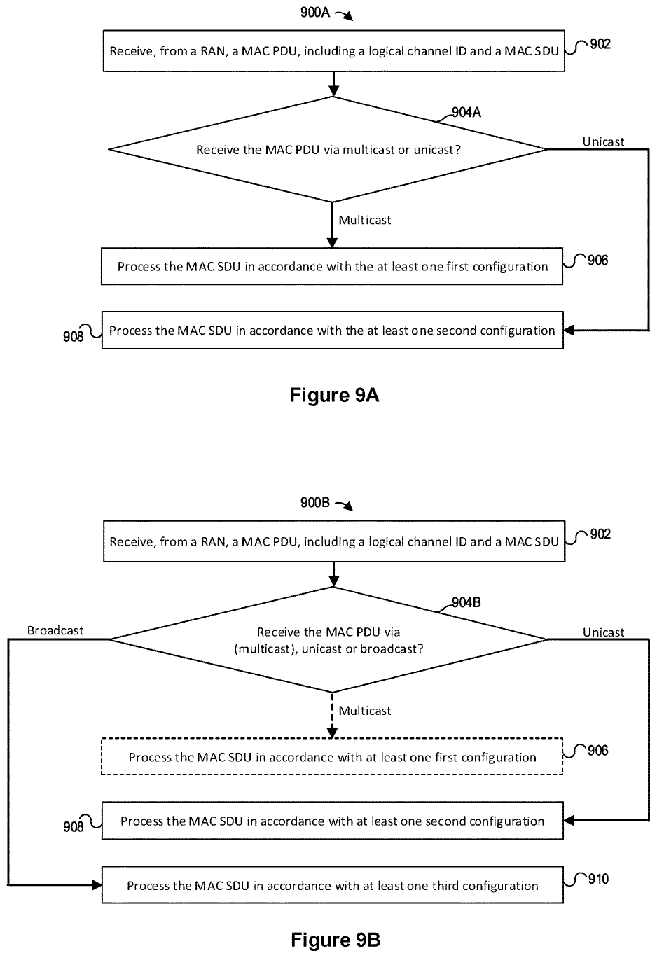

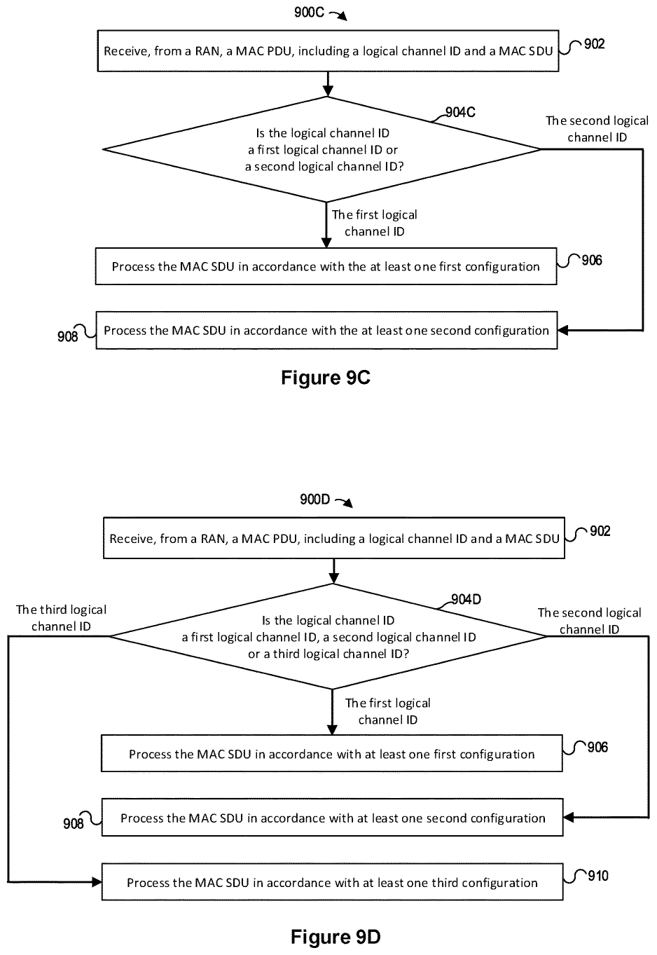

Next, several example methods which devices illustrated in FIGS. 1A and 1B can implement are discussed with reference to FIGS. 6A-14. Each of these methods can be implemented as a set of instructions stored on a non-transitory computer-readable medium and executable by one or more processors. FIGS. 6A-8 and 10A-13 illustrate methods that can be implemented by a RAN node, and FIGS. 9A-9D and 14 illustrate methods that can be implemented by a UE. Blocks that are labeled with the same reference numbers in different figures (e.g., block 602 in FIG. 6A and block 602 in FIG. 6B) are similar.

Referring first to FIG. 6A, a RAN node such as the DU 174 or base station 104 can implement a method 600A to transmit data packets received from a CU or a CN. The method 600A begins at block 602, where the RAN node transmits, to the UE, first plural configuration parameters for at least one unicast RB (e.g., SRB(s) and/or DRB(s)). At block 604, the RAN node transmits, to a UE, second plural configuration parameters for configuring an MRB (see, e.g., events 520, 593, 594, 595, 513). At block 606, the RAN node obtains a unicast service packet and an MBS packet and associated with the unicast RB and MRB, respectively (see, e.g., events 524, 526, 532, 534, 538, 540, 525, 527, 539, 541). At block 608, the RAN node refrains from including the unicast service packet and the MBS packet in a MAC PDU. At block 610, the RAN node generates a first MAC PDU and a second MAC PDU including (a portion of) the unicast service packet and (a portion of) the MBS packet, respectively. At block 612, the RAN node transmits the first MAC PDU and the second MAC PDU to the UE (see, e.g., events 528, 536, 542, 529, 543). In accordance with the method 600A, the RAN node refrains from multiplexing an MBS packet and a unicast service packet in the same PDU.

The blocks 610 and 612 are collectively referred to in FIG. 6A as a data transmission procedure 690.

In some implementations, the unicast service packet can be an IP packet, an Ethernet packet, a PDCP PDU including an IP packet, or a PDCP PDU including an Ethernet packet. In other implementations, the unicast service packet can be an RRC message or a PDCP PDU including an RRC message.

In some implementations, the RAN node receives the MBS packet and the unicast service packet via a common DL tunnel and a UE-specific DL tunnel, respectively. In cases where the RAN node is a DU, the common DL tunnel is a common CU-to-DU DL tunnel. In cases where the RAN node is a base station, the common DL tunnel is a common CN-to-BS DL tunnel. In other implementations, the RAN node receives the MBS packet and the unicast service packet via the common DL tunnel and a control-plane interface. In cases where the RAN node is a DU, the control-plane interface can be a F1-C interface. In cases where the RAN node is a base station, the control-plane interface can be a NG-C interface.

In some implementations, the first plural configuration parameters include at least one first logical channel ID, and the second plural configuration parameters include a second logical channel ID. The RAN node can include the first logical channel ID and the second logical channel ID in the first MAC PDU and second MAC PDU, respectively. Depending on the implementation, the first and second logical channel IDs can be the same logical channel ID, or different logical channel IDs. Likewise, depending on the implementation, the RAN node can set the first and second logical channel IDs to the same value, or to different values.

In some implementations, the DU receives CU-to-DU message(s) from the CU. The CU can indicate the at least one unicast RB (e.g., DRB or SRB) in the CU-to-DU message(s). In some implementations, the CU can include RB ID(s) of the unicast RB(s) in the CU-to-DU message(s). In cases where the unicast RB is an SRB, the RB ID can be a SRB ID. In cases where the unicast RB is a DRB, the RB ID is a DRB ID. In response to the CU-to-DU message, the DU determines to configure resources (e.g., the first RLC bearer configuration and/or the first logical channel ID) for the RB, and DU transmits DU-to-CU message(s) to the CU in response to the CU-to-DU message(s). In some implementations, the CU-to-DU message and the DU-to-CU message can be F1 application protocol (F1AP) messages. In some implementations, the CU-to-DU message and the DU-to-CU message can be a UE Context Setup Request message and a UE Context Setup Response message, respectively. In other implementations, the CU-to-DU message and the DU-to-CU message can be a UE Context Modification Request message and a UE Context Modification Response message, respectively.

In some implementations, the first plural configuration parameters include at least one first RLC bearer configuration, and the second plural configuration parameters include a second RLC bearer configuration. In some implementations, the first plural configuration parameters include at least one unicast RB configuration (e.g., SRB configuration(s) and/or DRB configuration(s)) configuring the at least one unicast RB, and the second plural configuration parameters include an MRB configuration configuring the MRB. In some implementations, the SRB configuration and the first RLC bearer configuration include the SRB ID. In some implementations, the DRB configuration and the first RLC bearer configuration include the DRB ID. In some implementations, the MRB configuration and the second RLC bearer configuration include the MRB ID. In some implementations, the MRB configuration includes a first MBS session ID identifying a first MBS session.

In some implementations, the RAN node receives a second MBS packet associated with the MRB. In such cases, the RAN node can include the second MBS packet in the second MAC PDU. In some implementations, the RAN node receives a third MBS packet associated with a second MRB associated to the first MBS session or a second MBS session. The RAN node can transmit, to the UE, configuration parameters for configuring the second MRB. In such cases, the RAN node can include the third MBS packet in the second MAC PDU. Alternatively, the RAN node refrains from including the third MBS packet in the second MAC PDU. In this case, the RAN node generates a third MAC PDU including the third MBS packet and transmit the third MAC PDU to the UE. The RAN can include a third logical channel ID in the third MAC PDU. In some implementations, the RAN node can set the third logical channel ID to a value different from the first logical channel ID and/or the second logical channel ID. In other implementations, the RAN node can set the third logical channel ID to a value same as the first logical channel ID or the second logical channel ID.

In cases where the RAN node includes a portion of the unicast service packet, the RAN node generates first additional MAC PDU(s) including remaining portion(s) of the unicast service packet respectively. In cases where the RAN node includes a portion of the MBS packet, the RAN node generates second additional MAC PDU(s) including remaining portion(s) of the MBS packet. In such cases, the RAN node refrains from including a portion of the first unicast service packet and a portion of the MBS packet in a MAC PDU.

The CU generates one or more DL messages (e.g., RRC reconfiguration message(s)) including the first plural configuration parameters and transmits the DL message(s) to the UE via the DU.

In some implementations, the first plural configuration parameters include a logical channel configuration (e.g., mac-LogicalChannelConfig field or LogicalChannelConfig IE) and the second plural configuration parameters might or might not include a logical channel configuration (e.g., mac-LogicalChannelConfig field or LogicalChannelConfig IE). In other implementations, the first configuration parameters include uplink configuration parameters for a MAC layer (e.g., ul-SpecificParameters) and the second configuration parameters might or might not include uplink configuration parameters for a MAC layer (e.g., ul-SpecificParameters). In yet other implementations, the first plural configuration parameters include a logical channel group (e.g., logicalChannelGroup), a subcarrier spacing list (e.g., allowedSCS-List), a scheduling request ID (e.g., schedulingRequestedID field or SchedulingRequestedId IE), a timer value (e.g., bitRateQueryProhibitTimer), a physical priority index (e.g., allowedPHY-PriorityIndex), a channel access priority (e.g., channelAccessPriority) and/or a bitrate multiplier (e.g., a bitRateMultiplier). In some implementations, the second plural configuration parameters might or might not include a logical channel group (e.g., logicalChannelGroup), a subcarrier spacing list (e.g., allowedSCS-List), a scheduling request ID (e.g., schedulingRequestedID field or SchedulingRequestedId IE), a timer value (e.g., bitRateQueryProhibitTimer), a physical priority index (e.g., allowedPHY-PriorityIndex), a channel access priority (e.g., channelAccessPriority) and/or a bitrate multiplier (e.g., a bitRateMultiplier).

FIG. 6B is a flow diagram of an example method 600B, similar to the method 600A of FIG. 6A, except that method 600B includes blocks 611 and 613 instead of blocks 608, 610 and 612. At block 611, the RAN node generates a MAC PDU including (a portion of) the unicast service packet and (a portion of) the MBS packet. At block 613, the RAN node transmits the MAC PDU to the UE (see, e.g., events 528, 536, 542, 529, 539, 543). In accordance with the method 600B and in contrast to the method 600A, the RAN node can multiplex a unicast service packet and an MBS packet in the same PDU.

The blocks 611 and 613 are collectively referred to in FIG. 6B as a data transmission procedure 691.

In some implementations, the RAN node receives the unicast service packet and the MBS packet via a first UE-specific DL tunnel and a second UE-specific DL tunnel, respectively. In cases where the RAN node is a DU, the first and second UE-specific DL tunnels are UE-specific CU-to-DU DL tunnels. In cases where the RAN node is a base station, the first and second UE-specific DL tunnels are UE-specific CN-to-BS DL tunnels. In other implementations, the RAN node receives the unicast service packet and the MBS packet via the control-plane interface and a UE-specific DL tunnel, respectively.

In some implementations, the RAN node receives a second MBS packet associated with the MRB. In such cases, the RAN node can include the second MBS packet in the MAC PDU. In some implementations, the RAN node receives a third MBS packet associated with a second MRB. The RAN node can transmit, to the UE, configuration parameters for configuring the second MRB. In such cases, the RAN node can include the third MBS packet in the MAC PDU. Alternatively, the RAN node refrains from including the third MBS packet in the MAC PDU. In this case, the RAN node generates a second MAC PDU including the third MBS packet and transmit the second MAC PDU to the UE. The RAN can include the third logical channel ID in the second MAC PDU.

In cases where the RAN node includes a portion of the unicast service packet, the RAN node generates first additional MAC PDU(s) including remaining portion(s) of the unicast service packet respectively. In cases where the RAN node includes a portion of the MBS packet, the RAN node generates second additional MAC PDU(s) including remaining portion(s) of the MBS packet. In such cases, the RAN node might or might not include a portion of the first unicast service packet and a portion of the MBS packet in a MAC PDU.

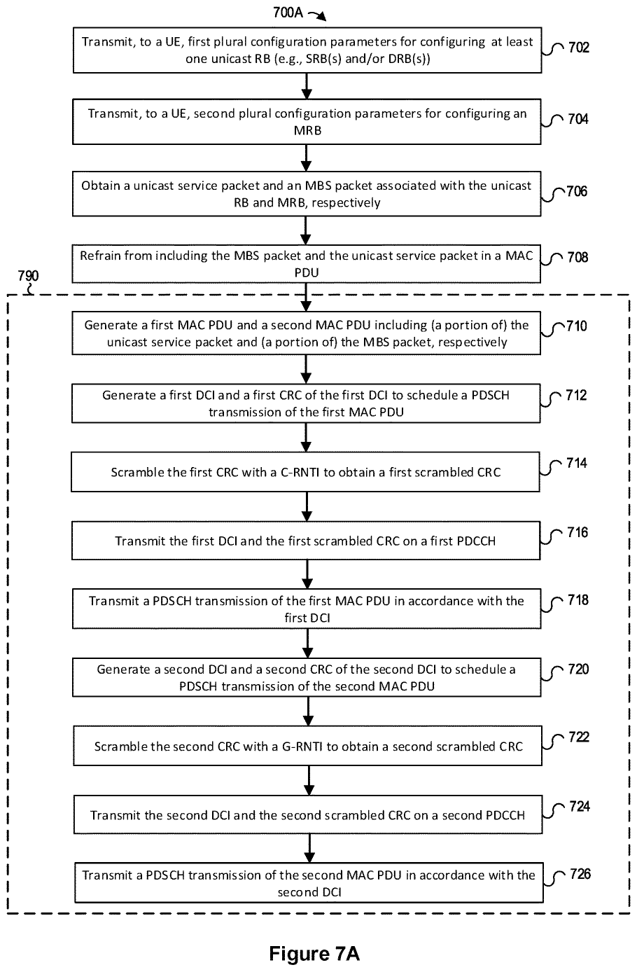

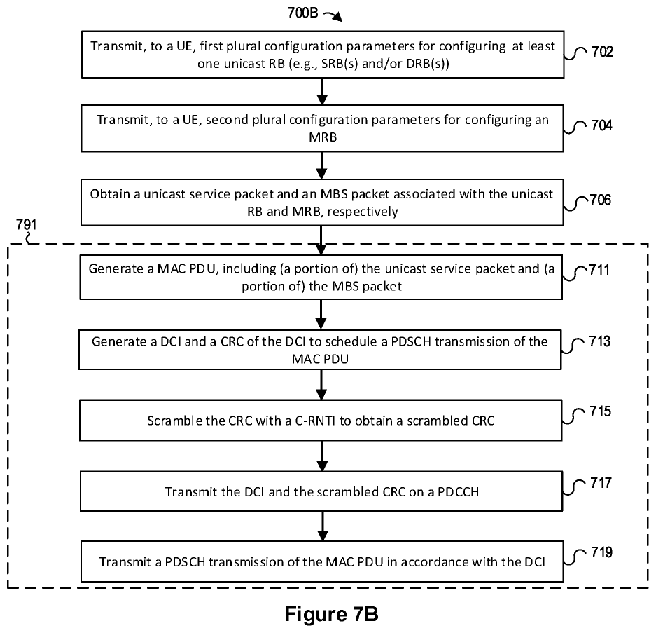

FIG. 7A is a flow diagram of an example method 700A, similar to the method 600A of FIG. 6A, where blocks 702-710 are the same as blocks 602-610, respectively. FIG. 7A further includes using a C-RNTI to scramble a CRC of a DCI scheduling the first MAC PDU (i.e., the MAC PDU including the unicast service packet), and using a G-RNTI to scramble a CRC of a DCI scheduling the second MAC PDU (i.e., the MAC PDU including the MBS packet). More particularly, at block 712, the RAN node generates a first DCI and a first CRC of the first DCI to schedule a PDSCH transmission of the first MAC PDU. At block 714, the RAN node scrambles the first CRC with a C-RNTI to obtain a first scrambled CRC. At block 716, the RAN node transmits the first DCI and the first scrambled CRC on a first PDCCH. At block 718, the RAN node transmits a PDSCH transmission of the first MAC PDU in accordance with the first DCI. At block 720, the RAN node generates a second DCI and a second CRC of the second DCI to schedule a PDSCH transmission of the second MAC PDU. At block 722, the RAN node scrambles the second CRC with a G-RNTI to obtain a second scrambled CRC. At block 724, the RAN node transmits the second DCI and the second scrambled CRC on a second PDCCH (see, e.g., events 528, 536, 542, 529, 539, 543). At block 726, the RAN node transmits a PDSCH transmission of the second MAC PDU in accordance with the second DCI (see, e.g., events 528, 536, 542, 529, 539, 543).

The blocks 710, 712, 714, 716, 718, 720, 722, 724 and 726 are collectively referred to in FIG. 7A as a data transmission procedure 790.

In some implementations, the RAN node receives a second MBS packet associated with the second MRB as described for FIG. 6A. To transmit the third MAC PDU, the RAN node generates a third DCI and a third CRC of the third DCI to schedule a PDSCH transmission of the third MAC PDU. The RAN node then scrambles the third CRC with a second G-RNTI to obtain a third scrambled CRC. The RAN node transmits the third DCI and the third scrambled CRC on a third PDCCH and transmits a PDSCH transmission of the third MAC PDU in accordance with the third DCI.

FIG. 7B is a flow diagram of an example method 700B, similar to the method 600B of FIG. 6B, where blocks 702, 704, 706 and 711 are the same as blocks 602, 604, 606 and 611, respectively. FIG. 7B further includes using a C-RNTI to scramble a CRC of a DCI scheduling the MAC PDU (i.e., the MAC PDU including the unicast service and the MBS packet. Specifically, at block 713, the RAN node generates a DCI and a CRC of the DCI to schedule a PDSCH transmission of the MAC PDU. At block 715, the RAN node scrambles the CRC with a C-RNTI to obtain a scrambled CRC. At block 717, the RAN node transmits the DCI and the scrambled CRC on a PDCCH (see, e.g., events 528, 536, 542, 529, 539, 543). At block 719, the RAN node transmits a PDSCH transmission of the MAC PDU in accordance with the DCI (see, e.g., events 528, 536, 542, 529, 539, 543).

The blocks 711, 713, 715, 717 and 719 are collectively referred to in FIG. 7B as a data transmission procedure 791.

In some implementations, the RAN node receives a second MBS packet associated with the second MRB as described for FIG. 6B. To transmit the second MAC PDU, the RAN node generates a second DCI and a second CRC of the second DCI to schedule a PDSCH transmission of the second MAC PDU. In cases where the RAN node does not assign a G-RNTI for an MBS session to which the second MRB is associated, the RAN node then scrambles the second CRC with the C-RNTI to obtain a second scrambled CRC. In cases where the RAN node assigns a G-RNTI for an MBS session to which the second MRB is associated, the RAN node then scrambles the second CRC with the G-RNTI to obtain a second scrambled CRC. The RAN node transmits the second DCI and the second scrambled CRC on a second PDCCH and transmits a PDSCH transmission of the second MAC PDU in accordance with the second DCI.

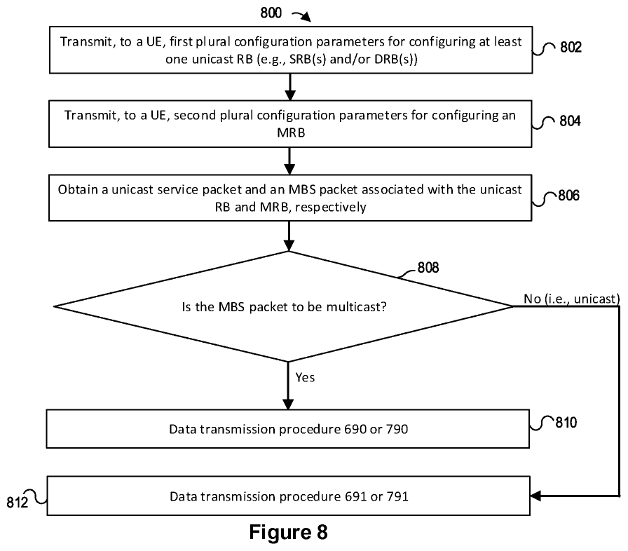

FIG. 8 is a flow diagram of an example method 800, similar to the method 600A, 600B, 700A and 700B, where blocks 802, 804, 806 are the same as blocks 602, 604, 606 and blocks 702, 704, 706 respectively. At block 808, the RAN node determines whether the MBS packet is to be multicast. If the RAN node determines that the MBS packet is to be multicast, the flow proceeds to block 810. At block 810, the RAN node performs the data transmission procedure 690 or 790 (i.e., the data transmission procedures illustrated in FIG. 6A and FIG. 7A, respectively). If the RAN node determines that the MBS packet is to be unicast, the flow proceeds to block 812. At block 812, the RAN node performs the data transmission procedure 691 or 791 (i.e., the data transmission procedures illustrated in FIG. 6B and FIG. 7B, respectively).

Turning to FIGS. 9A-9D, a UE can implement example methods for determining which configuration(s) to apply to process a received MAC PDU. Blocks of the methods discussed with reference to FIGS. 9A-9D that are similar are labeled with the same reference numbers (e.g., blocks 902 in FIGS. 9A-9D, blocks 906 in FIGS. 9A-9D, blocks 908 in FIGS. 9A-9D, and blocks 910 in FIGS. 9B and 9D).

Now referring to FIG. 9A, a UE such as the UE 102, 103 can implement an example method 900A to determine which configuration(s) to apply to process a received MAC PDU.

The method 900A begins at block 902, where the UE receives, from a RAN, a MAC PDU including a logical channel ID and a MAC SDU (see, e.g., events 528, 536, 542). At block 904A, the UE determines whether the UE received the MAC PDU via multicast or unicast (see, e.g., events 528, 536, 542). When the UE determines that the MAC PDU was received via multicast, the flow proceeds to block 906. At block 906, the UE processes the MAC SDU in accordance with the at least one first configuration (see, e.g., events 528, 536, 542). When the UE determines that the MAC PDU was received via unicast, the flow proceeds to block 908. At block 908, the UE processes the MAC SDU in accordance with the at least one second configuration. The first and second configurations are discussed below, following the description of FIG. 9D.

FIG. 9B illustrates an example method 900B similar to method 900A, except that method 900B includes blocks 904B and 910 instead of block 904A.

At block 904B, the UE determines whether the UE received the MAC PDU via (multicast), unicast or broadcast (see, e.g., events 528, 536, 542, 529, 543). The flow proceeds to block 906, 908, or 910 when the UE determines that the MAC PDU was received via multicast, unicast or broadcast, respectively (see, e.g., events 528, 536, 542, 529, 543). At block 910, the UE processes the MAC SDU in accordance with at least one third configuration (see, e.g., events 529, 543).

FIG. 9C illustrates an example method 900C similar to method 900A, except that method 900C includes block 904C instead of block 904A.

At block 904C, the UE determines whether the logical channel ID is a first logical channel ID or a second logical channel ID. When the UE determines that the logical channel ID is a first logical channel ID, the flow proceeds to block 906. When the UE determines that the logical channel ID is a second logical channel ID, the flow proceeds to block 908.

FIG. 9D illustrates an example method 900D similar to methods 900B, except that method 900D includes block 904D instead of blocks 904B.

At block 904D, the UE determines whether the logical channel ID is a first logical channel ID, a second logical channel ID or a third logical channel ID. The flow proceeds to block 906, 908, or 910 when the UE determines the logical channel ID is a first logical channel ID, a second logical channel ID or a third logical channel ID, respectively.

The following examples and implementations can apply to FIGS. 9A-9D.

In some implementations, the UE receives the logical channel ID (value) (or the first logical channel ID in FIGS. 9C-9D) and the at least one first configuration for configuring an MRB (e.g., a first MRB) from the RAN (see e.g., events 520, 593, 594, 595). In some implementations, the UE can configure (e.g., (re)establish or set up) at least one first entity in accordance with the at least first configuration. The UE processes the MAC SDU in accordance with the at least one first entity. For example, the at least one first configuration includes a first RLC configuration (e.g., RLC-BearerConfig IE or RLC-Config IE) and/or a first PDCP configuration (e.g., PDCP-Config IE), and the at least one first entity includes a first RLC entity and/or a first PDCP entity. In some implementations, the first RLC entity processes the MAC SDU (i.e., RLC PDU) in accordance with the first RLC configuration to obtain a PDCP PDU, and the first PDCP entity processes the PDCP PDU to obtain a PDCP SDU (e.g., an IP packet, Ethernet packet or a SDAP PDU). In some implementations, the at least one first configuration includes a SDAP configuration (e.g., SDAP-Config IE). In such cases, the at least one first entity can include a SDAP entity and the UE processes the PDCP SDU (i.e., a SDAP PDU) to obtain a packet (e.g., IP packet or Ethernet packet). In some implementations, the logical channel ID (or the first logical channel ID, in FIGS. 9C-9D) is included in the at least one first configuration.

In some implementations, the UE receives the logical channel ID (or the second logical channel ID, in FIGS. 9C-9D) and the at least one second configuration for configuring a DRB or a SRB from the RAN. In such cases, the UE can configure (e.g., (re)establish or set up) at least one second entity in accordance with the at least second configuration. The UE processes the MAC SDU in accordance with the at least one second entity. For example, the at least one second configuration includes a second RLC configuration (e.g., RLC-BearerConfig IE or RLC-Config IE) and/or a second PDCP configuration (e.g., PDCP-Config IE), and the at least one second entity includes a second RLC entity and/or a second PDCP entity. In some implementations, the second RLC entity processes the MAC SDU (i.e., RLC PDU) in accordance with the second RLC configuration to obtain a PDCP PDU, and the second PDCP entity processes the PDCP PDU to obtain a PDCP SDU (e.g., an IP packet, Ethernet packet or a SDAP PDU). In some implementations, the at least one second configuration includes a SDAP configuration (e.g., SDAP-Config IE). In such cases, the at least one second entity can include a SDAP entity and the UE processes the PDCP SDU (i.e., a SDAP PDU) to obtain a packet (e.g., IP packet or Ethernet packet). In some implementations, the logical channel ID (or the second logical channel ID, in FIGS. 9C-9D) is included in the at least one second configuration.

In some implementations, the UE receives the logical channel ID (or the third logical channel ID, in FIGS. 9C-9D) and/or the at least one third configuration for configuring an MRB (e.g., a second MRB) from the RAN (see e.g., event 513). Alternatively, the UE is preconfigured with the logical channel ID and/or the at least one third configuration instead of receiving the logical channel ID and/or the at least one third configuration from the RAN. In this case, the logical channel ID and/or the at least third configuration can be specified or defined in 3GPP specification(s). In some implementations, the UE can configure (e.g., (re)establish or set up) at least one third entity in accordance with the at least third configuration. The UE processes the MAC SDU in accordance with the at least one third entity. In some implementations, the logical channel ID (or the third logical channel ID, in FIGS. 9C-9D) is included in the at least one third configuration. For example, the at least one third configuration includes a third RLC configuration (e.g., RLC-BearerConfig IE or RLC-Config IE) and/or a third PDCP configuration (e.g., PDCP-Config IE), and the at least one third entity includes a third RLC entity and/or a third PDCP entity. In some implementations, the third RLC entity processes the MAC SDU (i.e., RLC PDU) in accordance with the third RLC configuration to obtain a PDCP PDU, and the third PDCP entity processes the PDCP PDU to obtain a PDCP SDU (e.g., an IP packet, Ethernet packet or a SDAP PDU). In some implementations, the at least one third configuration includes a SDAP configuration (e.g., SDAP-Config IE). In such cases, the at least one third entity can include a SDAP entity and the UE processes the PDCP SDU (i.e., a SDAP PDU) to obtain a packet (e.g., IP packet or Ethernet packet).

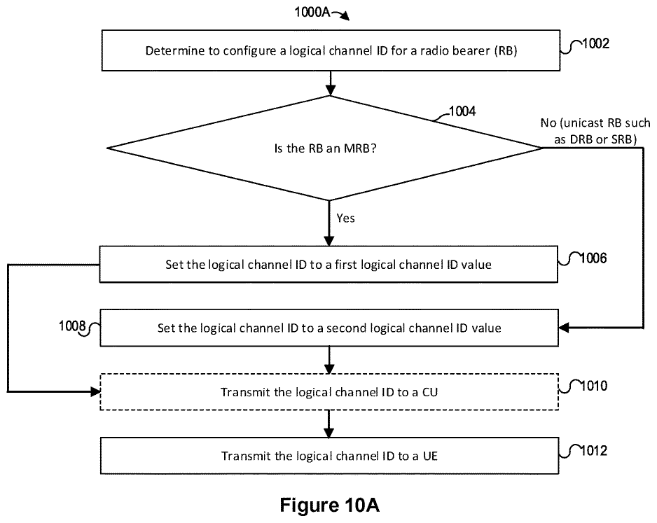

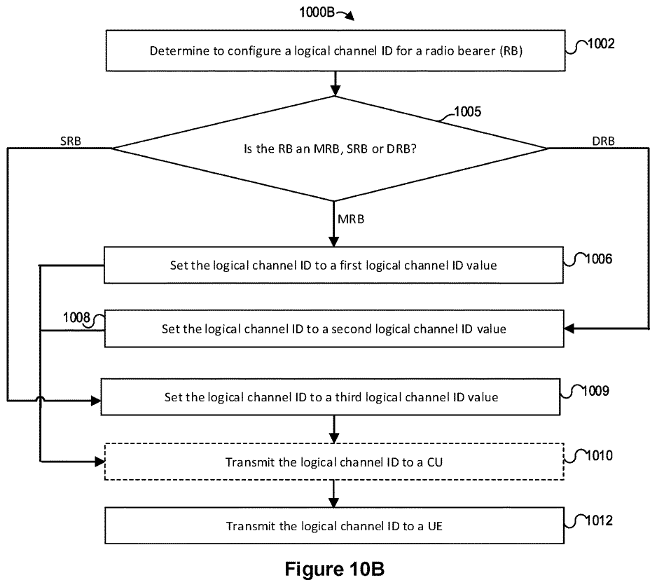

Referring next to FIG. 10A, a RAN node such as the DU 174 or base station 104 can implement a method 1000A to configure a logical channel ID for a radio bearer, based on whether the radio bearer is an MRB.

The method 1000A begins at block 1002, where the RAN node determines to configure a logical channel ID for a radio bearer (RB). At block 1004, the RAN node determines whether the RB is an MRB. When the RAN node determines that the RB is an MRB, the flow proceeds to block 1006. At block 1006, the RAN node sets the logical channel ID to a first logical channel ID value. When the RAN node determines that the RB is a unicast RB (i.e., DRB or SRB), the flow proceeds to block 1008. At block 1008, the RAN node sets the logical channel ID to a second logical channel ID value.

In cases where the RAN node is a DU, from block 1006 or 1008, the flow proceeds to block 1010, and from block 1010 to block 1012. Otherwise, the flow proceeds directly to block 1012 from block 1006 or 1008. At block 1010, the RAN node transmits the logical channel ID to a CU. At block 1012, the RAN node transmits the logical channel ID to a UE.

In accordance with the method 1000A, the RAN node refrains from using the same logical channel ID value for an MRB and a unicast RB (i.e., DRB or SRB).

If the RB is an MRB, the RAN node (e.g., a base station or a CU of the base station) in some implementation can set an ID of the RB to a first RB ID value. If the RB is a unicast RB, the RAN (e.g., base station) in some implementation can set an ID of the RB to a second RB ID value. Then, the RAN node transmits the ID of the RB to the UE. Thus, the RAN node refrains from using the same RB ID value for an MRB and a unicast RB.

In some implementations, the RAN node can perform the method 1000A for other UE(s). In cases where the RAN node determines to configure the other UE(s) with the MRB, the RAN node can set the logical channel ID for the MRB to the first logical channel ID value for the other UE(s). In cases where the RAN node determines to configure the other UE(s) with the unicast RB, the RAN node can set the logical channel ID for the unicast RB (e.g., DRB or SRB) to the second logical channel ID value for the other UE(s).

In some implementations, the RAN node can predetermine the first logical channel ID value and the second logical channel ID value. As such, the RAN node does not need to identify which logical channel ID value has been configured for unicast RB(s) when the RAN node needs to configure the logical channel ID for the MRB. This simplifies an implementation of the RAN node to configure an MRB.

In some further implementations, the RAN node can reserve or predetermine a first set of logical channel ID values for configuring one or more MRBs and a second set of logical channel ID values for configuring one or more unicast RBs. The first set and second set do not have the same logical channel ID values. When the RAN node configures the logical channel ID for the MRB, the RAN node sets the logical channel ID for the MRB to an unused logical channel ID value in the first set. When the RAN node configures the logical channel ID for the unicast RB, the RAN node refrains from setting the logical channel ID to a logical channel ID value in the first set. Instead, the RAN node sets the logical channel ID for the unicast RB to an unused logical channel ID value in the second set. The unused logical channel ID value is a logical channel ID value that the RAN has not configured for an RB.

FIG. 10B illustrates an example method 1000B similar to method 1000A, except that method 1000B includes blocks 1005 and 1009 instead of block 1004.

At block 1005, the RAN node determines whether the RB is an MRB, SRB or DRB. The flow proceeds to block 1006, 1008, or 1009 when the RAN node determines the RB is an MRB, DRB or SRB, respectively. At block 1009, the RAN node sets the logical channel ID to a third logical channel ID value. In cases where the RAN node is a DU, from block 1006, 1008, or 1009, the flow proceeds to block 1010, and from block 1010 to block 1012. Otherwise, the flow proceeds directly to block 1012 from block 1006, 1008, or 1009.

In accordance with the method 1000B, the RAN node refrains from using the same logical channel ID value for an MRB, a DRB or an SRB.

If the RB is an MRB, the RAN node (e.g., base station) in some implementation can set an ID of the RB to a first RB ID value. If the RB is a DRB, the RAN node (e.g., base station) in some implementation can set an ID of the RB to a second RB ID value. If the RB is an SRB, the RAN node (e.g., base station) in some implementation can set an ID of the RB to a third RB ID value. Then, the RAN node transmits the ID of the RB to the UE. Thus, the RAN node refrains from using the same RB ID value for an MRB, a DRB and an SRB.

In some implementations, the RAN node can perform the method 1000B for other UE(s). In cases where the RAN node determines to configure the other UE(s) with the MRB, the RAN node can set the logical channel ID for the MRB to the first logical channel ID value for the other UE(s). In cases where the RAN node determines to configure the other UE(s) with the DRB, the RAN node can set the logical channel ID for the DRB to the second logical channel ID value for the other UE(s). In cases where the RAN node determines to configure the other UE(s) with the SRB, the RAN node can set the logical channel ID for the SRB to the third logical channel ID value for the other UE(s).

In some implementations, the RAN node can predetermine the first logical channel ID value, the second logical channel ID value and the third logical channel ID value. As such, the RAN node does not need to identify which logical channel ID value has been configured for a DRB or SRB when the RAN node needs to configure the logical channel ID for the MRB. This simplifies an implementation of the RAN node to configure an MRB.

In some implementations, the RAN node can reserve or predetermine a first set of logical channel ID values for configuring one or more MRBs, a second set of logical channel ID values for configuring one or more DRBs and a third set of logical channel ID values for configuring one or more SRBs. The first, second and third sets do not have the same logical channel ID values. When the RAN node configures the logical channel ID for the MRB, the RAN sets the logical channel ID for the MRB to an unused logical channel ID value in the first set. When the RAN node configures the logical channel ID for the DRB, the RAN node sets the logical channel ID for the DRB to an unused logical channel ID value in the second set. When the RAN node configures the logical channel ID for the SRB, the RAN node sets the logical channel ID for the SRB to an unused logical channel ID value in the third set.

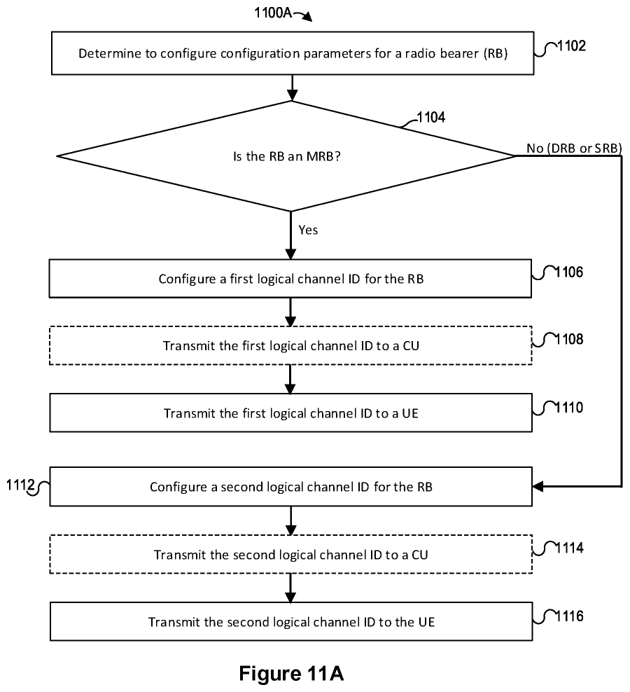

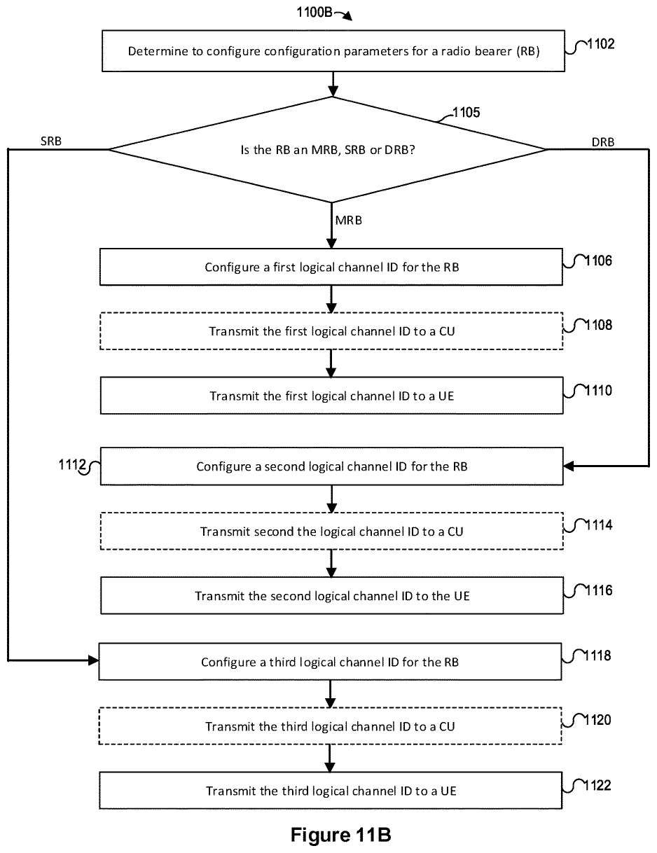

Referring next to FIG. 11A, a RAN node such as the DU 174 or base station 104 can implement a method 1100A to configure a logical channel ID.

The method 1100A begins at block 1102, where the RAN node determines to configure configuration parameters for a radio bearer (RB). At block 1104, the RAN node determines whether the RB is an MRB. If the RAN node determines the RB is an MRB, the flow proceeds to block 1106. At block 1106, the RAN node configures a first logical channel ID for the RB. From block 1106, the flow proceeds (i) to block 1108, if the RAN node is a DU, and then to block 1110, or (ii) directly to block 1110. At block 1108, the RAN node transmits the first logical channel ID to a CU. At block 1110, the RAN node transmits the first logical channel ID to a UE. Otherwise, if the RAN node determines the RB is not an MRB (i.e., DRB or SRB), the flow proceeds to block 1112. At block 1112, the RAN node configures a second logical channel ID for the RB. From block 1112, the flow proceeds (i) to block 1114, if the RAN node is a DU, and then to block 1116, or (ii) directly to block 1116. At block 1114, the RAN node transmits the logical channel ID to a CU. At block 1116, the RAN node transmits the logical channel ID to the UE.

In accordance with the method 1100A, the RAN node configures a second logical channel ID for the RB and refrains from using the same logical channel ID for an MRB and a unicast RB (i.e., DRB or SRB).

In some implementations, the first logical channel ID and the second logical channel ID have different types. In other implementations, the first logical channel ID and the second logical channel ID have the same type. Depending on the implementation, the RAN node can set the first logical channel ID and the second logical channel ID to different values or to the same value.

If the RB is an MRB, the RAN node (e.g., a base station or a CU of the base station) in some implementation can configure an MRB ID for the MRB. If the RB is a unicast RB (i.e., DRB or SRB), the RAN node (e.g., base station) in some implementation can configure an RB ID (i.e., DRB ID or SRB ID) for the non-multicast RB. Thus, the RAN node refrains from using the same RB ID for an MRB and a unicast RB. Depending on the implementation, the MRB ID and the RB ID (i.e., DRB ID or SRB ID) can have different types or the same type. Likewise, depending on the implementation, the RAN node can set the MRB ID and the RB ID to different values or the same value.

In some implementations, the RAN node can perform the method 1100A for other UE(s). In cases where the RAN node determines to configure the other UE(s) with the MRB, the RAN node can set the first logical channel ID for the MRB to the first logical channel ID value for the other UE(s). In cases where the RAN determines to configure the other UE(s) with the unicast RB, the RAN node can set the second logical channel ID for the unicast RB (e.g., DRB or SRB) to the second logical channel ID value for the other UE(s).

In some implementations, the RAN node can predetermine the first logical channel ID value and the second logical channel ID value. As such, the RAN node does not need to identify which logical channel ID value has been configured for unicast RB(s) when the RAN node needs to configure the logical channel ID for the MRB. This simplifies an implementation of the RAN node to configure an MRB.

In some further implementations, the RAN node can reserve or predetermine a first set of logical channel ID values for configuring one or more MRBs and a second set of logical channel ID values for configuring one or more unicast RBs. The first set and second set do not have the same logical channel ID values. When the RAN node configures the first logical channel ID for the MRB, the RAN node sets the first logical channel ID for the MRB to an unused logical channel ID value in the first set. When the RAN node configures the second logical channel ID for the unicast RB, the RAN node refrains from setting the second logical channel ID to a logical channel ID value in the first set. Instead, the RAN node sets the second logical channel ID for the unicast RB to an unused logical channel ID value in the second set. The unused logical channel ID value is a logical channel ID value that the RAN node has not configured for an RB.

FIG. 11B illustrates an example method 1100B similar to method 1100A, except that method 1100B includes blocks 1105, 1118, 1120 and 1122 instead of block 1104. At block 1105, the RAN node determines whether the RB is an MRB, SRB or DRB. The flow proceeds to block 1106, 1112, or 1118 when the RAN node determines the RB is an MRB, DRB or SRB, respectively.

When the RAN node determines the RB is an SRB, the flow proceeds to block 1118. At block 1118, the RAN node configures a third logical channel ID for the RB. From block 1118, the flow proceeds (i) to block 1120, if the RAN node is a DU, and then to block 1122, or (ii) directly to block 1122. At block 1120, the RAN node transmits the third logical channel ID to a CU. At block 1122, the RAN node transmits the third logical channel ID to a UE.

In accordance with the method 1100B, the RAN node refrains from using the same logical channel ID for an MRB, a DRB and a SRB. In some implementations, at least two or all of the first, second and third logical channel IDs have different types. In other implementations, at least two or all of the first, second and third logical channel IDs have the same type. In some implementations, the RAN node can set at least two or all of the first, second and third logical channel IDs to different values. In other implementations, the RAN node can set at least two or all of the first, second and third logical channel IDs to the same value.

If the RB is an MRB, the RAN node (e.g., a base station or a CU of the base station) in some implementation can configure an MRB ID for the MRB. If the RB is a DRB, the RAN node (e.g., base station) in some implementation can configure a DRB ID for the DRB. If the RB is an SRB, the RAN node in some implementation can configure a SRB ID for the SRB. Thus, the RAN node refrains from using the same RB ID for an MRB, a DRB and an SRB. In some implementations, at least two or all of the MRB ID, the DRB ID and the SRB ID have different types. In other implementations, at least two or all of the MRB ID, the DRB ID and the SRB ID have the same type. In some implementations, the RAN node can set at least two or all of the MRB ID, the DRB ID and the SRB ID to different values. In other implementations, the RAN node can set at least two or all of the MRB ID, the DRB ID and the SRB ID to the same value.

In some implementations, the RAN node can perform the method 1100B for other UE(s). In cases where the RAN node determines to configure the other UE(s) with the MRB, the RAN node can set the first logical channel ID for the MRB to the first logical channel ID value for the other UE(s). In cases where the RAN node determines to configure the other UE(s) with the DRB, the RAN node can set the second logical channel ID for the DRB to the second logical channel ID value for the other UE(s). In cases where the RAN node determines to configure the other UE(s) with the SRB, the RAN node can set the third logical channel ID for the SRB to the third logical channel ID value for the other UE(s).

In some implementations, the RAN node can predetermine the first logical channel ID value, the second logical channel ID value and the third logical channel ID value. As such, the RAN node does not need to identify which logical channel ID value has been configured for a DRB or SRB when the RAN node needs to configure the logical channel ID for the MRB. This simplifies an implementation of the RAN node to configure an MRB.

In some implementations, the RAN node can reserve or predetermine a first set of logical channel ID values for configuring one or more MRBs, a second set of logical channel ID values for configuring one or more DRBs and a third set of logical channel ID values for configuring one or more SRBs. The first, second and third sets do not have the same logical channel ID values. When the RAN node configures the first logical channel ID for the MRB, the RAN node sets the first logical channel ID for the MRB to an unused logical channel ID value in the first set. When the RAN node configures the second logical channel ID for the DRB, the RAN node sets the second logical channel ID for the DRB to an unused logical channel ID value in the second set. When the RAN node configures the third logical channel ID for the SRB, the RAN node sets the third logical channel ID for the SRB to an unused logical channel ID value in the third set.

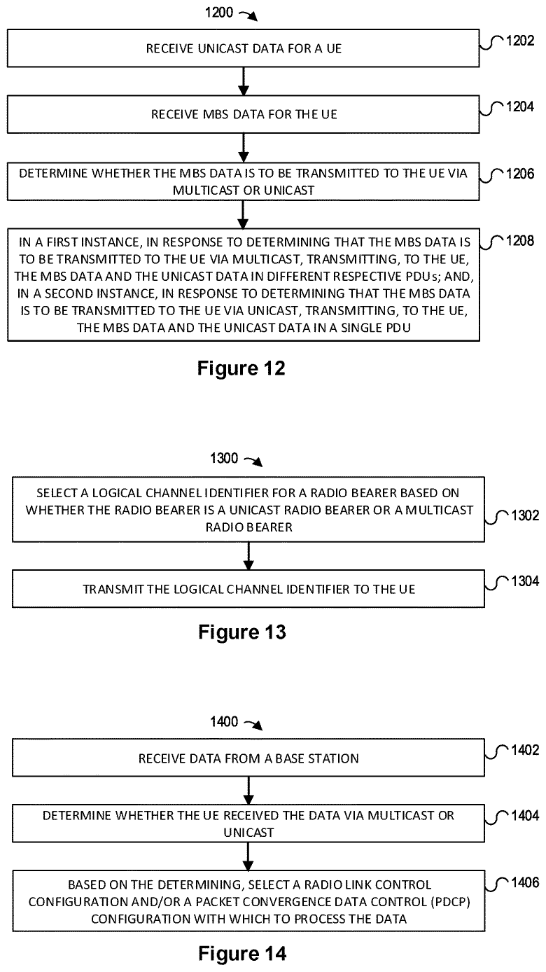

Referring to FIG. 12, a base station (e.g., the base station 104 or 106) can implement a method 1200 for transmitting MBS to a UE (e.g., the UE 102 or 103). The method may be implemented by processing hardware (e.g., the processing hardware 130 or 140). At block 1202, the base station receives unicast data for the UE (e.g., block 606, 706, 806), and at block 1204, the base station receives MBS data for the UE (e.g., block 606, 706, 806). At block 1206, the base station determines whether the MBS data is to be transmitted to the UE via multicast or unicast (e.g., block 808). At block 1208, the base station: in a first instance, in response to determining that the MBS data is to be transmitted to the UE via multicast, transmits, to the UE, the MBS data and the unicast data in different respective PDUs (e.g., data transmission procedure 690 or 790, block 810); and, in a second instance, in response to determining that the MBS data is to be transmitted to the UE via unicast, transmits, to the UE, the MBS data and the unicast data in a single PDU (e.g., data transmission procedure 691 or 791, block 812).

Turning to FIG. 13, a base station (e.g., the base station 104 or 106) can implement a method 1300 for configuring radio bearers for transmissions to a UE (e.g., the UE 102 or 103). The method may be implemented by processing hardware (e.g., the processing hardware 130 or 140). At block 1302, the base station selects a logical channel identifier (e.g., a logical channel ID) for a radio bearer based on whether the radio bearer is a unicast radio bearer or a multicast radio bearer (e.g., block 1004, 1005, 1104, 1105). At block 1304, the base station transmits the logical channel identifier to the UE (e.g., block 1010, 1012, 1108, 1110, 1114, 1116, 1120, 1122).

Referring next to FIG. 14, a UE (e.g., the UE 102 or 103) can implement a method 1400 for processing transmissions received from a base station (e.g., the base station 104 or 106). The method may be implemented by processing hardware (e.g., the processing hardware 150). At block 1402, the UE receives data from the base station (e.g., block 902). At block 1404, the UE determines whether the UE received the data via multicast or unicast (e.g., block 904A, 904B, 904C, 904D). At block 1406, the UE, based on the determining at block 1404, selects an RLC configuration and/or a PDCP configuration with which to process the data (e.g., block 906, 908, 910).

The following list of examples reflects a variety of the embodiments explicitly contemplated by the present disclosure:

Example 1. A method in a base station for transmitting multicast and/or broadcast services (MBS) to a user equipment (UE), the method comprising: receiving, by processing hardware of the base station, unicast data for the UE; receiving, by the processing hardware, MBS data for the UE; determining, by the processing hardware, whether the MBS data is to be transmitted to the UE via multicast or unicast; in a first instance, in response to determining that the MBS data is to be transmitted to the UE via multicast, transmitting, by the processing hardware to the UE, the MBS data and the unicast data in different respective PDUs; and in a second instance, in response to determining that the MBS is to be transmitted to the UE via unicast, transmitting, by the processing hardware to the UE, the MBS data and the unicast data in a single PDU.

Example 2. The method of example 1, wherein, in the second instance, transmitting the single PDU includes transmitting the single PDU to the UE via unicast.

Example 3. The method of example 2, wherein transmitting the single PDU includes: scrambling a cyclic redundancy check (CRC) using a temporary identifier dedicated to the UE; transmitting, to the UE, with the CRC, scheduling information for receiving the single PDU; and unicasting the single PDU in accordance with the scheduling information.

Example 4. The method of example 1, wherein, in the first instance, transmitting the different respective PDUs includes: transmitting a first PDU of the different respective PDUs to the UE via multicast, the first PDU including the MBS data; and transmitting a second PDU of the different respective PDUs to the UE via unicast, the second PDU including the unicast data.

Example 5. The method of example 4, wherein: transmitting the first PDU includes: scrambling a first cyclic redundancy check (CRC) using a group temporary identifier; transmitting, to the UE, with the first CRC, first scheduling information for receiving the first PDU; and transmitting, via multicast, the first PDU in accordance with the first scheduling information; and transmitting the second PDU includes: scrambling a second CRC using a temporary identifier dedicated to the UE; transmitting, to the UE, with the second CRC, second scheduling information for receiving the second PDU; and transmitting, via unicast, the second PDU in accordance with the second scheduling information.

Example 6. The method of example 4 or 5, further comprising: transmitting, by the processing hardware to the UE, a first configuration configuring a multicast radio bearer; transmitting, by the processing hardware to the UE, a second configuration configuring a unicast radio bearer, the second configuration different from the first configuration, wherein: transmitting the first PDU includes transmitting the first PDU using the multicast radio bearer; and transmitting the second PDU includes transmitting the second PDU using the unicast radio bearer.

Example 7. The method of example 6, further comprising: transmitting, by the processing hardware to the UE, a first logical channel identifier for the multicast radio bearer; and transmitting, by the processing hardware to the UE, a second logical channel identifier for the unicast radio bearer, the second logical channel identifier different from the first logical channel identifier.

Example 8. The method of any one of the preceding examples, wherein: in the first instance, transmitting the single PDU includes transmitting the single PDU formatted in accordance with a medium access control (MAC) protocol layer; and in the second instance, transmitting the different respective PDUs includes transmitting the different respective PDUs, each of the respective PDUs formatted in accordance with a MAC protocol layer.

Example 9. A method in a base station for configuring radio bearers for transmissions to a user equipment (UE), the method comprising: selecting, by the processing hardware, a logical channel identifier for a radio bearer based on whether the radio bearer is a unicast radio bearer or a multicast radio bearer; and transmitting by the processing hardware, the logical channel identifier to the UE.

Example 10. The method of example 9, wherein selecting the logical channel identifier for the radio bearer includes: setting the logical channel identifier to a value based on whether the radio bearer is the unicast radio bearer or the multicast radio bearer.

Example 11. The method of example 10, wherein setting the logical channel identifier includes: in a first instance, when the radio bearer is the unicast radio bearer, setting the logical channel identifier to a first value; and in a second instance, when the radio bearer is the multicast radio bearer, setting the logical channel identifier to a second value, the second value different from the first value.

Example 12. The method of example 11, wherein: in the first instance, setting the logical identifier to the first value includes selecting the first value from a first set of values; and in the second instance, setting the logical identifier to the second value includes selecting the second value from a second set of values, the second set of values non-overlapping with the first set of values.

Example 13. The method of example 10, wherein setting the logical channel identifier includes: in a first instance, when the radio bearer is the unicast radio bearer, the unicast radio bearer for conveying user plane data, setting the logical channel identifier to a first value; in a second instance, when the radio bearer is the unicast radio bearer, the unicast radio bearer for conveying signaling, setting the logical channel identifier to a second value; and in a third instance, when the radio bearer is the multicast radio bearer, setting the logical channel identifier to a third value, the first value, the second value, and the third value corresponding to different respective values.

Example 14. The method of example 9, wherein selecting the logical channel identifier for the radio bearer includes: in a first instance, when the radio bearer is the unicast radio bearer, configuring the logical channel identifier as a first type; and in a second instance, when the radio bearer is the multicast radio bearer, configuring the logical channel identifier as a second type, the second type different from the first type.

Example 15. The method of example 9, wherein selecting the logical channel identifier for the radio bearer includes: in a first instance, when the radio bearer is the unicast radio bearer, the unicast radio bearer for conveying user plane data, configuring the logical channel identifier as a first type; in a second instance, when the radio bearer is the unicast radio bearer, the unicast radio bearer for conveying signaling, configuring the logical channel identifier as a second type; and in a third instance, when the radio bearer is the multicast radio bearer, configuring the logical channel identifier as a third type, the first type, the second type, and the third type corresponding to different respective types.

Example 16. The method of any one of examples 9-15, wherein: the base station includes a central unit (CU) and a distributed unit (DU); selecting the logical channel identifier includes: selecting, at the DU, the logical channel identifier; and transmitting, from the DU to the CU, the logical channel identifier.

Example 17. A base station comprising processing hardware and configured to implement a method according to any one of the preceding examples.

Example 18. A method in a user equipment (UE) for processing transmissions received from a base station, the method comprising: receiving, by the processing hardware, data from the base station; determining, by the processing hardware, whether the UE received the data via multicast or unicast; and based on the determining, selecting, by the processing hardware, a radio link control (RLC) configuration and/or a packet data convergence protocol (PDCP) configuration, with which to process the data.

Example 19. The method of example 18, wherein the selecting includes: selecting the RLC configuration from at least two RLC configurations and/or the PDCP configuration from at least two PDCP configurations, the at least two RLC configurations including a first RLC configuration configuring a multicast radio bearer and a second RLC configuration configuring a unicast radio bearer, and the at least two PDCP configurations including a first PDCP configuration configuring the multicast radio bearer and a second PDCP configuration configuring the unicast radio bearer.

Example 20. The method of example 18 or 19, wherein: receiving the data includes receiving, with the data, a logical channel identifier; and determining whether the UE received the data via multicast or unicast based on the logical channel identifier.

Example 21. The method of any one of examples 18-20, wherein: receiving the data includes receiving a protocol data unit (PDU) including a signaling data unit (SDU); and selecting the RLC configuration and/or the PDCP configuration includes selecting the RLC configuration and/or the PDCP configuration, with which to process the SDU.

Example 22. A user equipment (UE) comprising processing hardware and configured to implement a method according to any one of examples 18-21.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102 or 103) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for communicating MBS information through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a base station for transmitting multicast and/or broadcast services (MBS) to a user equipment (UE), the method comprising:
receiving, by the base station, unicast data for the UE;
receiving, by the base station, MBS data for the UE; and
transmitting, by the base station to the UE, the MBS data and the unicast data in different respective PDUs without multiplexing the MBS data and the unicast data.

2. The method of claim 1, wherein transmitting the different respective PDUs includes:
transmitting a first PDU of the different respective PDUs to the UE via multicast, the first PDU including the MBS data; and
transmitting a second PDU of the different respective PDUs to the UE via unicast, the second PDU including the unicast data.

3. The method of claim 2, wherein:
transmitting the first PDU includes:
scrambling a first cyclic redundancy check (CRC) using a group temporary identifier;
transmitting, to the UE, with the first CRC, first scheduling information for receiving the first PDU; and
transmitting, via multicast, the first PDU in accordance with the first scheduling information; and
transmitting the second PDU includes:
scrambling a second CRC using a temporary identifier dedicated to the UE;
transmitting, to the UE, with the second CRC, second scheduling information for receiving the second PDU; and
transmitting, via unicast, the second PDU in accordance with the second scheduling information.

4. The method of claim 2, further comprising:
transmitting, by the base station to the UE, a first configuration configuring a multicast radio bearer;
transmitting, by the base station to the UE, a second configuration configuring a unicast radio bearer, the second configuration different from the first configuration.
wherein:
transmitting the first PDU includes transmitting the first PDU using the multicast radio bearer; and
transmitting the second PDU includes transmitting the second PDU using the unicast radio bearer.

5. The method of claim 4, further comprising:
transmitting, by the base station to the UE, a first logical channel identifier for the multicast radio bearer; and
transmitting, by the base station to the UE, a second logical channel identifier for the unicast radio bearer, the second logical channel identifier different from the first logical channel identifier.

6. The method of claim, wherein:
the different respective PDUs, each of the respective PDUs formatted in accordance with a MAC protocol layer.

7. A method in a base station for configuring radio bearers for transmissions to a user equipment (UE), the method comprising:
selecting, by the base station, a logical channel identifier for a radio bearer based on whether the radio bearer is a unicast radio bearer or a multicast radio bearer; and
transmitting by the base station, the logical channel identifier to the UE.

8. The method of claim 7, wherein selecting the logical channel identifier for the radio bearer includes:
setting the logical channel identifier to a value based on whether the radio bearer is the unicast radio bearer or the multicast radio bearer.

9. The method of claim 8, wherein setting the logical channel identifier includes:
in a first instance, when the radio bearer is the unicast radio bearer, setting the logical channel identifier to a first value; and
in a second instance, when the radio bearer is the multicast radio bearer, setting the logical channel identifier to a second value, the second value different from the first value.

10. The method of claim 9, wherein:
in the first instance, setting the logical channel identifier to the first value includes selecting the first value from a first set of values; and
in the second instance, setting the logical channel identifier to the second value includes selecting the second value from a second set of values, the second set of values non-overlapping with the first set of values.

11. The method of claim 8, wherein setting the logical channel identifier includes:
in a first instance, when the radio bearer is the unicast radio bearer, the unicast radio bearer for conveying user plane data, setting the logical channel identifier to a first value;
in a second instance, when the radio bearer is the unicast radio bearer, the unicast radio bearer for conveying signaling, setting the logical channel identifier to a second value; and
in a third instance, when the radio bearer is the multicast radio bearer, setting the logical channel identifier to a third value, the first value, the second value, and the third value corresponding to different respective values.

12. The method of claim 7, wherein selecting the logical channel identifier for the radio bearer includes:
in a first instance, when the radio bearer is the unicast radio bearer, configuring the logical channel identifier as a first type; and
in a second instance, when the radio bearer is the multicast radio bearer, configuring the logical channel identifier as a second type, the second type different from the first type.

13. The method of claim 7, wherein selecting the logical channel identifier for the radio bearer includes:
in a first instance, when the radio bearer is the unicast radio bearer, the unicast radio bearer for conveying user plane data, configuring the logical channel identifier as a first type;
in a second instance, when the radio bearer is the unicast radio bearer, the unicast radio bearer for conveying signaling, configuring the logical channel identifier as a second type; and
in a third instance, when the radio bearer is the multicast radio bearer, configuring the logical channel identifier as a third type, the first type, the second type, and the third type corresponding to different respective types.

14. The method of claim 7, wherein:
the base station includes a central unit (CU) and a distributed unit (DU);
selecting the logical channel identifier includes:
selecting, at the DU, the logical channel identifier; and
transmitting, from the DU to the CU, the logical channel identifier.

15. An apparatus functioning as a base station, configured to transmit multicast and/or broadcast services (MBS) to a user equipment (UE), the apparatus comprising:
a transceiver; and
processing hardware configured to:
receive unicast data for the UE;
receive MBS data for the UE; and
transmit, to the UE, the MBS data and the unicast data in different respective PDUs without multiplexing the MBS data and the unicast data.

16. The apparatus of claim 15, wherein transmitting the different respective PDUs includes:
transmitting a first PDU of the different respective PDUs to the UE via multicast, the first PDU including the MBS data; and
transmitting a second PDU of the different respective PDUs to the UE via unicast, the second PDU including the unicast data.

17. The apparatus of claim 16, wherein:
transmitting the first PDU includes:
scrambling a first cyclic redundancy check (CRC) using a group temporary identifier;
transmitting, to the UE, with the first CRC, first scheduling information for receiving the first PDU; and
transmitting, via multicast, the first PDU in accordance with the first scheduling information; and
transmitting the second PDU includes:
scrambling a second CRC using a temporary identifier dedicated to the UE;
transmitting, to the UE, with the second CRC, second scheduling information for receiving the second PDU; and
transmitting, via unicast, the second PDU in accordance with the second scheduling information.

18. The apparatus of claim 16, wherein the processing hardware is further configured to:
transmit, to the UE, a first configuration configuring a multicast radio bearer;
transmit, to the UE, a second configuration configuring a unicast radio bearer, the second configuration different from the first configuration.
wherein:
transmitting the first PDU includes transmitting the first PDU using the multicast radio bearer; and
transmitting the second PDU includes transmitting the second PDU using the unicast radio bearer.

19. The apparatus of claim 18, wherein the processing hardware is further configured to:
transmit, to the UE, a first logical channel identifier for the multicast radio bearer; and
transmit, to the UE, a second logical channel identifier for the unicast radio bearer, the second logical channel identifier different from the first logical channel identifier.

20. The apparatus of claim 15, wherein:
transmitting the different respective PDUs includes transmitting the different respective PDUs, each of the respective PDUs formatted in accordance with a MAC protocol layer.
